(19) United States
(12) Patent Application Publication
(10) Pub. No.: US 2025/0322520 A1
(43) Pub. Date: Oct. 16, 2025

(54) AUTOMATED IMAGE INFERENCE FROM WHOLE-BODY MEDICAL IMAGES

(71) Applicant: ANTAROS MEDICAL AB, Mölndal (SE)

(72) Inventors: Joel KULLBERG, Uppsala (SE); Hanna JÖNSSON, Solna (SE)

(21) Appl. No.: 18/869,406

(22) PCT Filed: May 31, 2023
(86) PCT No.: PCT/EP2023/064597

§ 371 Date: Nov. 26, 2024

(30) Foreign Application Priority Data
Jun. 2, 2022 (SE) 2250662-0
Jun. 2, 2022 (SE) 2250663-8
Jun. 2, 2022 (SE) 2250664-6

(51) Int. Cl. G06T 7/00; G06T 7/10; G06T 7/32

(52) U.S. Cl. CPC G06T 7/0014; G06T 7/10; G06T 7/32; G06T 2207/10081; G06T 2207/10104; G06T 2207/20081; G06T 2207/20084; G06T 2207/30096; G06T 2207/30196

(57) ABSTRACT

A method for preparing a tool for automated image inference comprises providing (S25) of a neural network to be trained. Multiple training subject data sets are obtained (S30), comprising whole-body medical images of an associated training subject registered to a respective set common image and an assigned image inference of the associated subject. At least one whole-body divergence image that is based on a comparison between the whole-body medical image of the respective associated training subject and collective image information of a group of subjects is obtained (S32) and registered (S36) to the set common image space. The neural network is trained (S40) with the training subject data sets. A method for automated image inference and a tool for automated image inference is also disclosed.

### TECHNICAL FIELD

The present invention relates in general to methods and devices for processing of body images and in particular to automated image inference methods and devices based on whole-body PET and CT images.

### BACKGROUND

In modern health care, analysis using different imaging techniques, is often used. Common imaging techniques are e.g. Positron Emission Tomography (PET), which uses radioactive so-called radiotracers to identify and measure changes in metabolic processes or other physiological activities. Computed Tomography (CT) use rotating X-rays and detectors placed in a gantry to measure X-ray attenuations in different tissues inside the body. By using image analysis, such images may assist e.g., in diagnosis of different diseases.

However, after a diagnosis is made by a physician or in separate research studies, different types of images can also be used as tools for assisting in treatment planning, measuring of metabolic processes, segmentation of different types of tissues or other types of non-diagnostic inference. Such investigations are often based on comparisons between images of a specific subject with images of other subjects, the same subject but at another instant or some statistical information.

In “Anomaly detection for the individual analysis of brain PET images”, by N. Burgos et al, Journal of Medical Imaging (Bellingham) 2021 March; 8(2): 024003subject-specific abnormality maps were created from PET images for different stages of Alzheimer's disease. The frame work was validated using the abnormality maps as inputs of a classifier and higher classification accuracies were obtained than when using the PET images themselves.

In “Improved Brain Lesion Segmentation with Anatomical Priors from Healthy Subjects”, by C. Liu et al, Medical Image Computing and Computer Assisted Intervention, MICCAI 2021, Lecture Notes in Computer Science, 12901, pp. 186-195, 20921 convolutional neural networks were used for brain lesion segmentation. Information in scans of healthy subjects to improve brain lesion segmentation. A set of reference scans of healthy subjects was registered to each scan with lesions, and the registered reference scans provide reference intensity samples of normal tissue at each voxel. Anomaly score maps were computed for the scan with lesions, and these maps are used as auxiliary inputs to the segmentation network to aid brain lesion segmentation.

In “Tumor Segmentation and Feature Extraction from Whole-Body FDG-PET/CT Using Cascaded 2D and 3D Convolutional Neural Networks”, by S. Jemaa et al, Journal of Digital Imaging (2020) 33:888-894, computer-assisted tumor segmentation in ¹⁸F-Fluorodeoxyglucose-positron emission tomography images is discussed. An end-to-end method leveraging 2D and 3D convolutional neural networks is presented to rapidly identify and segment tumors and to extract metabolic information in whole body FDG-PET/CT scans.

In “MRI white matter lesion segmentation using an ensemble of neural networks and overcomplete patch-based voting. Computerized Medical Imaging and Graphics”, by M. Herrera, et al, (2018) 69:43-51 https://doi.org/10.1016/j.compmedimag.2018.05.001, quantification of white matter hyperintensities (WMH) from Magnetic Resonance Imaging (MRI) was considered as a valuable tool for the analysis of normal brain ageing or neurodegeneration. Automatic extraction of WMH lesions is challenging due to their heterogeneous spatial occurrence, their small size and their diffuse nature. A segmentation was provided based on an ensemble of overcomplete patch-based neural networks.

In “¹⁸F-FDG PET/CT Uptake Classification in Lymphoma and Lung Cancer by Using Deep Convolutional Neural Networks”, by L. Sibille et al, Radiology: Volume 294: Number 2-February 2020 pp. 445-452, Fluorine 18 (18F)2fluorodeoxyglucose (FDG) PET/CT was discussed in connection with configurations of deep convolutional neural networks (CNNs) to localize and classify uptake patterns in patients with lung cancer and lymphoma. A fully automated anatomic localization and classification of fluorine 18-fluorodeoxyglucose PET uptake patterns in foci suspicious and nonsuspicious for cancer in patients with lung cancer and lymphoma by using a convolutional neural network was considered to be feasible and achieves high diagnostic performance when both CT and PET images are used.

In “Just another “Clever Hans” ?Neural networks and FDG PET-CT to predict the outcome of patients with breast cancer”, by M. Weber et al, European Journal of Nuclear Medicine and Molecular Imaging (2021) 48:3141-3150, the accuracy of a neural network in a cancer form that was not used for its training was evaluated. Although trained on lymphoma and lung cancer, PARS showed good accuracy in the detection of PERCIST measurable lesions. Therefore, the neural network seems not prone to the clever Hans effect. However, the network has poor accuracy if all manually segmented lesions were used as reference standard. Both the whole body and organ-wise MTV were significant prognosticators of overall survival in advanced breast cancer.

One area to which particular care has to be taken is the ability to make reliable comparisons between images of different subjects or different instances. Reliable registration of images to a common space is often a necessity for being able to obtain trustworthy inferences.

The prior art methods of registration are mainly divided into rigid and non-rigid transformations. The rigid transformations include rotation, scaling, translation, and other affine transforms. The non-rigid transformations allow for local warping of a target image in order to find the best fit between for example a target image and a source image.

Generally, image registration may often result in misalignment between two images when aligning the two, an error that may increase with increased complexity of the images to register. Images depicting large areas and/or volumes, e.g. whole-body images or images containing large portions of a body often affect image registration negatively due to increased complexity of the images.

In medical imaging for example, the images may contain a lot of image information and features such as different areas or volumes depicting different tissue information. Typically, the image information is reduced to a few measured parameters subsequent to image processing.

In the published PCT-application, WO2016/072926 A1, a method for image registration and analysis of MRI images are disclosed.

In the published U.S. Pat. No. 7,259,762 B2, a method for automatically transforming CT studies to a common reference frame to generate a statistical atlas is disclosed. Selected CT studies are transformed to a common reference frame and subsequently voxel-to-voxel correspondence is established between a CT and the statistical atlas.

However, there are requirements for improved registering methods.

Another aspect that may reduce the ability to make reliable comparisons is the limited amount of available comparison material. Since medical images e.g. PET and CT are radiation-based imaging methods, and require large and expensive equipment, PET and CT images are only recorded when being absolutely necessary. This means that the amount of available image comparison data is very limited, and is in general always associated with subjects having or being suspected to have different kinds of diseases. Statistical information deduced from such image data may be difficult to valuate in a proper way.

### SUMMARY

A general object is to improve image inference based on medical images.

The above object is achieved by methods and devices according to the independent claims. Preferred embodiments are defined in dependent claims.

In general words, in a first aspect, a method for preparing a tool for automated image inference comprises providing of a neural network to be trained. Multiple training subject data sets are obtained. Each training subject data set comprises at least one respective whole-body medical image of an associated subject and an assigned image inference of the associated subject. The method further comprises at least one of two part methods. In a first part method, the associated subject is a training subject in a respective set common image space of a common image, wherein each of the multiple training subject data sets further comprises at least one whole-body image of voxel-wise state of health, associated with the associated training subject, registered to the set common image space. The registered whole-body image(s) of voxel-wise state of health is(are) included into a respective training subject data set. The whole-body image(s) of voxel-wise state of health comprise(s) a whole-body divergence image that is based on a comparison between the whole-body medical image of the respective associated training subject and collective image information of a group of subjects. The step of obtaining multiple training subject data sets comprises obtaining of at least one whole-body image of voxel-wise state of health registered to the set common image space, in turn comprising obtaining whole-body medical images for the group of subjects. Whole-body medical images of the whole-body medical images for the group of subjects are registering to the set common image space by a common image registering routine. The whole-body divergence image is created by comparing the whole-body medical image of the respective associated training subject with registered whole-body medical images for the group of subjects. The common image registering routine comprises at least two part registering steps. In a second part method, the at least one respective whole-body medical image are whole-body medical images of at least two instances. The assigned image inference is an assigned image inference for at least one of the at least two instances. The second part method further comprises registering of whole-body medical images of the at least two instances and said assigned image inference for each subject to a set common image space of a set common image by use of a common image registering routine. In at least one of these part registering steps of any of the first and second part methods, images of different respective tissues in the whole-body medical images are obtained, and a part registering to the set common image space is performed by optimizing a weighted cost function. The cost function comprises a correlation of the images of respective tissues of the whole-body medical images to images of respective tissues of the set common image as well as a correlation of the whole-body medical image to a whole-body medical image of the set common image. Thereby, deformation parameters are obtained, defining the part registration for the whole-body medical image. The deformation parameters of one part registration step, except for a last part registration step, is used in a subsequent part registration step. The deformation parameters of the last part registration step is used for creating final registered whole-body medical images. Finally, the neural network is trained with the training subject data sets into a trained neural network.

In a second aspect, a method for automated image inference comprises providing of a trained neural network. The trained neural network is trained with training subject data sets. The training subject data sets comprises at least one respective whole-body medical image, and an assigned image inference of an associated subject. A subject data set of at least one whole-body medical image of an associated subject is obtained. The trained neural network is operated with the subject data set as input data, resulting in an image inference. The method further comprises at least one of two part methods. In the first part method, the training subject data sets further comprises at least one training whole-body image of voxel-wise state of health, all registered to a set common image space of a set common image. The training whole-body image(s) of voxel-wise state of health comprise(s) a whole-body divergence image based on a comparison between the whole-body medical image of the respective associated training subject and collective image information of a group of subjects. The obtained subject data set is a subject data set comprising at least one whole-body medical image of an associated subject registered to a common image space of a common image, and at least one whole-body image of whole-body image of voxel-wise state of health registered to the common image space. The whole-body image(s) of voxel-wise state of health comprise(s) a whole-body divergence image that is based on a comparison between the whole-body medical image of the respective associated training subject and collective image information of a group of subjects. The obtaining of the subject data set comprises obtaining of the whole-body image(s) of voxel-wise state of health registered to the common image space, in turn comprising obtaining of whole-body medical images for the group of subjects. Whole-body medical images of the whole-body medical images for the group of subjects are registered to the common image space by a common image registering routine. The whole-body divergence image is created by comparing the whole-body medical image of the associated subject with registered whole-body medical images for the group of subjects. In the second part method, the training subject data sets are training subject data sets of at least one respective whole-body medical image of at least two, non-simultaneous instances. The assigned image inference is an assigned image inference of an associated subject for at least one of said at least two instances for each training data set, registered to a respective set common image space. The subject data set is a subject data set of at least one whole-body medical image of at least two, non-simultaneous, instances of an associated subject. The second part method further comprises registering of whole-body medical images of the at least two instances to a common image space of a common image by use of a common image registering routine. The common image registering routine of any of the first and second part methods comprises at least two part registering steps. In at least one of these part registering steps images of different respective tissues in the whole-body medical images are obtained. A part registering to the common space is performed by optimizing a weighted cost function comprising a correlation of the images of respective tissues of the whole-body medical image to images of respective tissues of the common image as well as a correlation of the whole-body medical images to a whole-body medical image of the common image. Thereby deformation parameters are obtained, defining the part registration for the whole-body medical image. The deformation parameters of one part registration step, except for a last part registration step, is used in a subsequent part registration step and the deformation parameters of the last part registration step is used for creating final registered whole-body medical images.

In a third aspect, a tool for automated image inference comprises a processor, an input for subject data sets, an output for subject image inference and computer program instructions. The computer program instructions, when being executed by the processor, cause the processor to form a registered subject data set from a subject data set of at least one whole-body medical image. The computer program instructions, when being executed by the processor, further cause the processor to operate a trained neural network with the registered subject data set as input data, resulting in an image inference being provided to the output. The trained neural network is trained with registered training subject data sets of at least one respective whole-body medical image and an associated assigned image inference of an associated subject. The computer program instructions, when being executed by the processor, further cause the processor to operate a trained neural network with the registered subject data set as input data, resulting in an image inference being provided to the output. The computer program instructions, when being executed by the processor, further cause at least one of two part methods. In the first part method, the subject data set is a subject data set in a common space of a common image. The subject data set comprises at least one whole-body image of voxel-wise state of health obtained by the input, in a common space of a common image. The training subject data sets further comprises at least one training whole-body image of voxel-wise state of health, all registered to a set common image space of a set common image, where the at least one training whole-body image of voxel-wise state of health comprises a whole-body divergence image based on a comparison between the whole-body medical image of the respective associated training subject and collective image information of a group of subjects. The whole-body image(s) of voxel-wise state of health comprise(s) a whole-body divergence image that is based on a comparison between the whole-body medical image of the respective associated training subject and collective image information of a group of subjects. The computer program instructions, when being executed by the processor cause the processor to obtain whole-body medical images for the group of subjects, to register whole-body medical images of the whole-body medical images for the group of subjects to the common image space by a common image registering routine, and to create the whole-body divergence image by comparing the whole-body medical image of the associated subject with registered whole-body medical images for the group of subjects. In the second part method, the subject data set is a subject data set in a common space of a common image. The computer program instructions, when being executed by the processor, cause the processor to form a registered subject data set from at least one whole-body medical image, obtained by the input, of at least two, non-simultaneous, instances of an associated subject. The computer program instructions, when being executed by said processor, cause the processor to perform a registering of whole-body medical images of the at least two instances to a common image space of a common image by use of a common image registering routine. The trained neural network is trained with training subject data sets of at least one respective whole-body medical image of at least two, non-simultaneous, instances, and an assigned image inference of an associated subject for at least one of the at least two instances for each subject data set, registered to a respective set common image space. The common image registering routine of any of the first and second part methods comprises at least two part registering steps. In at least one of these part registering steps, images of different respective tissues in the whole-body medical images are obtained. A part registering to the common space is performed by optimizing a weighted cost function comprising a correlation of the images of respective tissues of the whole-body medical image to images of respective tissues of the common image as well as a correlation of the whole-body medical images to a whole-body medical image of the common image. Thereby deformation parameters are obtained, defining the part registration for the whole-body medical image. The deformation parameters of one part registration step, except for a last part registration step, is used in a subsequent part registration step and the deformation parameters of the last part registration step is used for creating final registered whole-body medical images. The computer program instructions, when being executed by the processor further cause the processor to operate a trained neural network with the registered subject data set as input data, resulting in an image inference being provided to the output. The trained neural network is trained with registered training subject data sets of at least one respective whole-body medical image, an associated assigned image inference of an associated subject and at least one training whole-body image of voxel-wise state of health, all registered to a set common image space of a set common image, where the at least one training whole-body image of voxel-wise state of health comprises a whole-body divergence image based on a comparison between the whole-body medical image of the respective associated training subject and collective image information of a group of subjects.

In a fourth aspect, computer program instructions, which when being executed by a processor, cause the processor to form a registered subject data set from an obtained subject data set of at least one whole-body medical image. whereby the computer program instructions, when being executed by the processor, further cause the processor to operate a trained neural network with the registered subject data set as input data, resulting in an image inference being provided to the output. The trained neural network is trained with registered training subject data sets of at least one respective whole-body medical image, an associated assigned image inference of an associated subject. The computer program instructions, when being executed by the processor, further cause the processor to operate a trained neural network with the registered subject data set as input data, resulting in an image inference being provided to the output. The computer program instructions, when being executed by the processor, further cause at least one of two part methods to occur. In the first part method, the subject data set is a subject data set in a common space of a common image. The subject data set comprises at least one whole-body image of voxel-wise state of health, in a common space of a common image. The training subject data sets further comprises at least one training whole-body image of voxel-wise state of health, all registered to a set common image space of a set common image, where the at least one training whole-body image of voxel-wise state of health comprises a whole-body divergence image based on a comparison between the whole-body medical image of the respective associated training subject and collective image information of a group of subjects. The whole-body image(s) of voxel-wise state of health comprise(s) a whole-body divergence image that is based on a comparison between the whole-body medical image of the respective associated training subject and collective image information of a group of subjects. The computer program instructions further cause the processor to obtain whole-body medical images for the group of subjects, to register whole-body medical images of the whole-body medical images for the group of subjects to the common image space by a common image registering routine, and to create the whole-body divergence image by comparing the whole-body medical image of the associated subject with registered whole-body medical images for the group of subjects. In the second part method, the subject data set (209) is a subject data set in a common space of a common image. The computer program instructions, when being executed by said processor, cause the processor to form a registered subject data set from at least one whole-body medical image, obtained by the input, of at least two, non-simultaneous, instances of an associated subject. The computer program instructions, when being executed by the processor, cause the processor to perform a registering of whole-body medical images of the at least two instances to a common image space of a common image by use of a common image registering routine. The trained neural network is trained with training subject data sets of at least one respective whole-body medical image of at least two, non-simultaneous, instances, and an assigned image inference of an associated subject for at least one of the at least two instances for each subject data set, registered to a respective set common image space. The common image registering routine of any of the first and second part methods comprises at least two part registering steps. In ate least one of these registering steps, images of different respective tissues in the whole-body medical images are obtained. A part registering to the common space is performed by optimizing a weighted cost function comprising a correlation of the images of respective tissues of the whole-body medical image to images of respective tissues of the common image as well as a correlation of the whole-body medical images to a whole-body medical image of the common image. Thereby deformation parameters are obtained, defining the part registration for the whole-body medical image. The deformation parameters of one part registration step, except for a last part registration step, is used in a subsequent part registration step and the deformation parameters of the last part registration step is used for creating final registered whole-body medical images. The computer program instructions further cause the processor to operate a trained neural network with the registered subject data set as input data, resulting in an image inference being provided. The trained neural network is trained with registered training subject data sets of at least one respective whole-body medical image, an associated assigned image inference of an associated subject and at least one training whole-body image of voxel-wise state of health, all registered to a set common image space of a set common image. The training whole-body image(s) of voxel-wise state of health comprise(s) a whole-body divergence image based on a comparison between the whole-body medical image of the respective associated training subject and collective image information of a group of subjects.

One advantage with the proposed technology is that the reliability of inferences based on medical images can be improved. Other advantages will be appreciated when reading the detailed description.

### BRIEF DESCRIPTION OF THE DRAWINGS

The invention, together with further objects and advantages thereof, may best be understood by making reference to the following description taken together with the accompanying drawings, in which:

FIG. 1 is a flow diagram of steps of an embodiment of a method for creating a whole-body health statistical atlas;

FIG. 2 is a flow diagram of steps of an embodiment of a method for creating a whole-body divergence image;

FIG. 3 is schematic illustration of an embodiment of a tool for creating a whole-body health statistical atlas;

FIG. 4 is a flow diagram of steps illustrating the use of a neural network;

FIG. 5 is a schematic illustration of an example of training and operating a neural network for automated image inference based on only whole-body medical images;

FIG. 6 is a schematic illustration of an embodiment of training and operating a neural network for automated image inference based on whole-body medical images as well as whole-body image of voxel-wise state of health;

FIG. 7 is a flow diagram of steps of an embodiment of a method for preparing a tool for automated image inference;

FIG. 8 is a flow diagram of steps of an embodiment of a method for automated image inference;

FIG. 9 is a flow diagram of steps of another embodiment of a method for preparing a tool for automated image inference;

FIG. 10 is a flow diagram of steps of another embodiment of a method for automated image inference;

FIG. 11 is schematic illustration of an embodiment of a tool for tool for automated image inference;

FIG. 12 is a schematic illustration of an embodiment of training and operating a neural network for automated image inference based on whole-body medical images of a subject recorded at different instances;

FIG. 13 is a flow diagram of steps of yet another embodiment of a method for preparing a tool for automated image inference;

FIG. 14 is a flow diagram of steps of yet another embodiment of a method for automated image inference;

FIG. 15 schematically illustrates a method according to at least one embodiment;

FIG. 16 schematically illustrates a method according to at least one embodiment;

FIG. 17 schematically illustrates a method according to at least one embodiment;

FIG. 18 schematically illustrates the different images according to at least one embodiment;

FIG. 19 schematically illustrates a comparison of the first image to the second image after registration of the first image to the second image according to at least one embodiment;

FIG. 20 schematically illustrates a comparison of the first image to a set of second images after registration of the first image to the set of second images according at least one embodiment;

FIG. 21 schematically illustrates a registration of a plurality of first images to a second image according to at least one embodiment;

FIG. 22 schematically illustrates acquisition of an image in an x-ray study according to at least one embodiment; and

FIG. 23 is a combination of the examples of FIGS. 5 and 12.

The figures are not necessarily to scale, and generally only show parts that are necessary in order to elucidate the inventive concept, wherein other parts may be omitted or merely suggested.

### DETAILED DESCRIPTION

Throughout the drawings, the same reference numbers are used for similar or corresponding elements.

One way, in modern technology, to improve analysis of complex sets of data is to use neural networks, also referred to as artificial intelligence or machine learning. A neural network structure, which may be rather general in its structure, is created. This neural network is then trained by a set of training data, where both intended input data as well as concluded results are comprised. The operation quality of the neural network when being used may to some part depend on the selected network structure, but the main contribution to the quality of the result when it is used depends on the selection of input data and the quality of the conclusions used during training. In general, the more training data that is used, the better results will be achieved.

Attempts to use neural networks for analyzing medical images, e.g. PET and CT images, have been performed. The standard solution is to use deep learning of a neural network with a training set of registered medical images associated with assigned image inference, e.g. a lesion segmentation. Medical images of a subject are then used as input data to the trained neural network, resulting in a suggested image inference. However, the results, although usually relatively useful, are still not extremely impressive.

The challenges are many. In cancer segmentation, small tumors give rise to sparse signals, which may disappear into the surrounding signals. Different standardized uptake values for contrast substances in different parts may cause differing signal levels. Biological intra or inter tumor heterogeneity concerning location, structure, perfusion, or metabolism may also influence the results. Brown fat and brain and heart constitutes high uptake regions and may be overvaluated. Time dependent activities in e.g., blood, liver, kidneys or bladder may disturb. Furthermore, different scanning details, varying from scanner to scanner may influence the results, and in particular if e.g., CT scans were performed with or without contrast. Also, implants may disturb the analysis.

One important factor for this partial failure is probably the above-mentioned limitation of available data that may be used as training input data and training inference. In order to improve the neural network results, the quality of the training input data and/or the amount of contributing input data has to be improved.

One factor that might improve the quality of a trained image-based neural network is to provide statistical information that may improve the ability for the neural network to become well-trained. Such statistical information, connected to the state of health can be provided for all parts of a body. In a medical image, each voxel can be associated to such statistical information. In the present disclosure, the term “whole-body image of voxel-wise state of health” is used as a common term of different such image-associated statistical information. Such whole-body image of voxel-wise state of health may be possible for the neural network to obtain on its own, by use of the image input data. However, if the amount of input data is limited, the optimization of the neural network both considering such whole-body image of voxel-wise state of health as well as the basic image information may be difficult to achieve. By instead supply the neural network with such explicit whole-body image of voxel-wise state of health, the training of the neural network regarding the basic image analysis may be facilitated. In the present disclosure, such whole-body image of voxel-wise state of health comprises information about health and/or diseases and in order to fit into the use together with whole-body medical images, e.g., CT and PET images.

Medical images may be of different types. Computed Tomography (CT) generates a tomographic image of x-ray attenuation of body tissues. CT is useful for many medical examinations and the backbone in cancer diagnostics and follow up. Photon counting CT scanners have recently been introduced allowing improved image resolution, reduced exposure to ionising radiation as well as more detailed analysis of x-ray attenuation properties, i.e. as multispectral or multi-channel images.

PET imaging allows both static and dynamic imaging of PET tracer concentrations. Many different PET tracers are available. FDG allows studies of tissue glucose metabolism and is very useful in oncology for primary diagnosis and treatment response assessment. One limitation of FDG is that it is unspecific to cancer and increased FDG uptake on PET image might indicate other physiological processes (for example inflammation). PET imaging allows molecular visualisation of specific receptors or antigens. PSMA is a more recently developed tracer that allows good sensitivity in prostate cancer diagnosis. PSMA accumulates specifically in tumor, as it binds to antigens expressed on the cancer cells. F18-FES is a PET tracer that specifically target oestrogen receptors which allows visualisation of oestrogen-positive lesions. Recent advances in PET scanner development have improved detector sensitivity and time of flight performance. Whole-body or large coverage PET scanners further allow improved PET imaging efficiency.

MRI uses strong magnetic fields and radio waves to generate tomographic images of the body in a non-invasive manner without the use of ionising radiation. A wide range of image contrast mechanisms can be used including water-fat MRI, T1- and T2-weighting and diffusion. MRI with both relative and quantitative image information is possible.

Imaging systems can also be integrated for example in PET-CT and PET-MR scanners allowing simultaneous multimodal imaging. Images from these systems can be considered to acquire images with good spatial alignment. They can therefore be considered registered. The image alignments might also for some scans and/or body regions and/or applications need improvement. In this case a limited deformation or registration of one image can be applied to make them more spatially aligned.

Multi-modal images can in proceeding processing be handled as to different signal channels. It is also possible to combine them into a synthetic combined image. This might be very complex to interpret for a human observer. A combined image might however be analysed in an efficient manner by for example a machine learning approach.

The quality of the whole-body image of voxel-wise state of health as well as for whole-body medical images also depends on the registration thereof. Registration approaches according to the background art presented further above may be sufficient in many cases. However, improved registration quality may together with the use of whole-body image of voxel-wise state of health give a synergetic effect.

Image registration can be used to achieve point-to-point correspondence between images. This can be used to standardize and merge information from groups of subjects and datasets. This can for example be used to create image atlases with voxel-wise statistical information on image properties or image derived properties and a subject's state of health.

One preferred routine for performing a whole-body image registering, and therefore also indirectly for whole-body image of voxel-wise state of health is presented in Appendix A. In short, this whole-body image registering routine comprises at least two part registering steps. In at least one of the part registering steps, images of different respective tissues in the whole-body medical images are obtained. A part registering to a common image space is performed. This part registration is performed by optimizing a weighted cost function: The cost function comprises a correlation of the images of respective tissues of the whole-body medical images to images of respective tissues of the common image as well as a correlation of the whole-body medical image to a whole-body medical image of the common image. Thereby deformation parameters are obtained, defining the part registration for the whole-body medical image.

In particular embodiments, the whole-body medical images are CT whole-body images or alternatively both CT and PET whole-body images. When both CT and PET whole-body images are used, the deformation parameters obtained by the CT whole-body images can be used for defining the whole-body PET image as well.

The deformation parameters of one part registration step are used in a subsequent part registration step. This is of course not valid for the very last part registration step. Instead, the deformation parameters of the last part registration step are used for creating final registered whole-body medical images.

More details and preferred embodiments of registration routines, exemplified by the particular application to CT and PET images, are presented in Appendix A, together with drawings supporting this appendix.

Image registration according to these principles can also be performed using a deep learning approach where a neural network is trained using example image data or through reinforcement learning using a loss function similar to the cost functions and/or optimization criterions used in the method described in Appendix A.

One approach to boost the learning efficiency of the neural network is to add prior knowledge of what healthy bodies look like. Such information may be extracted beforehand, and the learning process of the neural network does thereby gain a direct reference to what is “normal” and does not need to waste learning efforts to find such information through the provided training medical images. The health information can easily be provided as a whole-body health statistical atlas. Such a whole-body health statistical atlas may also be useful in other situations as well.

One problem with obtaining a whole-body health statistical atlas is that there are very few medical images, e.g. CT and PET images, of fully healthy subjects. A large majority of the available images comprises some “non-normal” parts. Therefore, a pure averaging of available medical images, regardless of if they are images of perfect healthy subjects or not, will introduce some false information into the whole-body health statistical atlas.

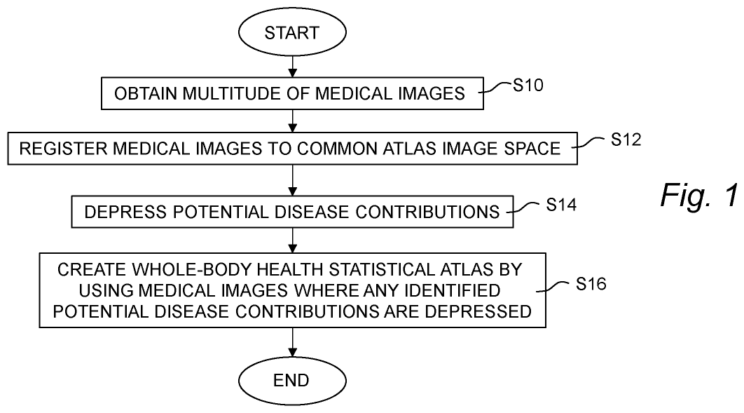

FIG. 1 illustrates a flow diagram of steps of an embodiment of a method for creating a whole-body health statistical atlas. In step S10, at least one whole-body medical image of a multitude of subjects are obtained. These whole-body medical images may or may not comprise disease-influenced parts. In step S12, whole-body medical images of the whole-body medical images of the multitude of subjects are registered to a common atlas image space of a common atlas image. All whole-body medical images of the multitude of subjects that are not already in the common atlas image space are registered. In a particular embodiment, all whole-body medical images of the multitude of subjects or all except one of whole-body medical images of the multitude of subjects are registered. The latter option is the case when the image space of one of the whole-body medical images in fact is the common atlas image space. Preferably, the step of registering is performed with the image registering routine presented here above and in Appendix A, where the common image space is the common atlas image space. Such a registration thus creates modified images that are aligned to each other. This makes it possible to compare the different subject images in a more objective manner. In step S14, any potential disease contributions are depressed from the whole-body medical images of the multitude of subjects. In such a way, non-normal contributions are excluded. In step S16 the whole-body health statistical atlas is created in the common atlas image space. This is performed by using the registered and potential-disease-contribution depressed whole-body medical images of the multitude of subjects. This creation does therefore not include potential disease information.

In the flow diagram, the step S14 is illustrated as following on the registration step S12. However, the opposite relation may also be feasible, i.e. where step S12 occurs after step S14.

In one embodiment, the at least one whole-body medical image comprises a whole-body CT image and optionally an additional whole-body PET image. In one embodiment, the common atlas image space is the image space of a whole-body medical image of one of the multitude of subjects.

In one embodiment, in step S14, the potential disease contributions are identified by human intervention. A skilled physician may point out abnormalities in the images, and these parts may then be assumed to involve some non-normal image information. Preferably, the potential disease contributions in the whole-body medical image of the multitude of subjects are identified, as a part of step S14, by defining of an envelope image volume of the whole-body medical image enclosing a volume that is identified by human intervention as a potential disease volume. The depressing of any identified potential disease contributions from the whole-body medical image information of the multitude of subjects then comprises removing of the envelope image volume not to be used during the step of creating the whole-body health statistical atlas. The information within this volume is thus requested not to be entered into the whole-body health statistical atlas.

Preferably, the envelope image volume encloses the volume that is identified by a human as a potential disease volume with a margin of at least one voxel in each direction, and preferably with at least two voxels in each direction. This gives a safety margin in order to securely remove any disease image contributions.

The action of “removing” a part of an image should be interpreted as excluding these voxels to be included in any following averaging or other statistical procedure.

In one embodiment, in step S14, the potential disease contributions are identified by statistical ways. Any potential disease contributions in the whole-body medical image of the multitude of subjects may be found in a more automated manner. To this end, step S14 is performed in the potential disease contributions in the whole-body medical image of the multitude of subjects are identified by comparing voxels of single whole-body medical images with mean, median, mode, or other nonparametric measures in view of distribution or variance measures of the whole-body medical image of the multitude of subjects. By this, voxels that differs considerably compared to what is usual, in the light of a normal uncertainty distribution, may be excluded from being used in the creation step. Instead, they may be treated to assume values according to the normal distributions. In other words, in the step S14, the depressing of any identified potential disease contributions from the whole-body medical image of the multitude of subjects preferably comprises treating of identified voxels according to distributions for a healthy synthetic subject.

Preferably, a z-score approach can be used in the above scenario. In other words, in one embodiment, the identifying of any potential disease contributions in the whole-body medical image of the multitude of subjects comprises determination of z-scores of the whole-body medical image. The z-scores comprise subject image intensity differences from an average-type measure for the group of subjects, scaled typically by a standard divergence of intensities for the group of subjects. The step S14 of depressing any identified potential disease contributions from the whole-body medical image of the multitude of subjects comprises removing of voxels having a z-score falling outside a predetermined range.

As mentioned above, the whole-body health statistical atlas can be useful in many applications, e.g. for image segmentation, image classification, image regression or for visual image evaluation. A useful tool that is often requested is an image that visualize parts of a whole body that is distinguished from normal conditions. In other words, a whole-body divergence image may often be of benefit. The creation of such a whole-body divergence image can be based on the whole-body health statistical atlas described above.

A whole-body divergence image may also be referred to as a whole-body deviation image.

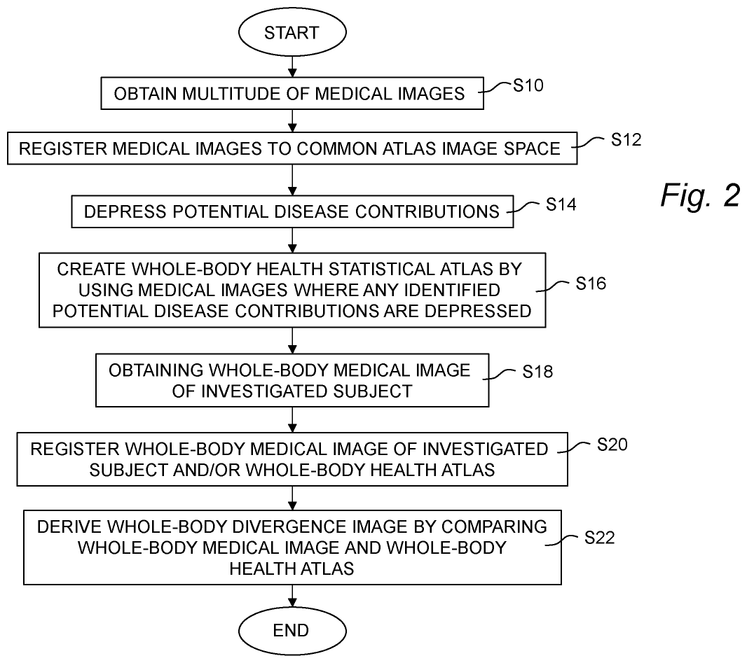

FIG. 2 is a flow diagram of steps of an embodiment of a method for creating a whole-body divergence image. Steps S10 to S16 are similar to the steps illustrated and described in connection with FIG. 1. These steps together create a whole-body health statistical atlas. In step S18, a whole-body medical image of an investigated subject is obtained. In step S20, at least one of the whole-body health statistical atlas and the whole-body medical image is registered to a common image space. This is performed using the image registering routine described further above and in Appendix A. In step S22, a whole-body divergence image is derived as a comparison between the whole-body medical image of the investigated subject and the whole-body health statistical atlas.

In a preferred embodiment, the common image space is the common atlas image space or an image space of the whole-body medical image of the investigated subject.

The resulting whole-body divergence image may be of use for highlighting parts of a whole body, where conditions considerably different from what is normally expected will be emphasized.

In one particular example, PET and CT images are registered to the image space of each individual PET-CT scan. An all-to-all image registration setup would require N*(N−1) registrations. However, if one would use image data in the validation fold one would risk bias the results. Therefore, only images from training folds are used and registered to respective validation fold. To reduce the number of registrations needed intermediate image spaces are also used in the form of explicitly selected scans. These consist of three scans of different body shapes and sizes in each fold (denoted: small, medium and large). These three are sampled targeting the 25, 50 and 75 percentiles of volumes of body fat as measured from the CT images. All images in respective fold are registered to its three intermediate images generating three intermediate atlases with the image data from all images in each fold. For each scan in the validation fold only the intermediate images are then registered to it, i.e. in total nine registrations (3 intermediate images×3 folds). All intermediate atlases are then combined into a full subject specific atlas.

A synthetic healthy atlas may then be created. As the PET-CT scans are from patients with varying amounts of lesions and other anomalies it is important to suppress the data from the anomalies. For this a statistical approach was applied voxel-wise. This was done by calculating Intensity percentiles at 25 and 75 percent (P25 and P75 respectively). Inter quartile range, IQR is calculated as P75-P25. Outlier intensities were identified as >P75+1.5xIQR or <P25-1.5xIQR and excluded from the atlas generating the final synthetic atlas.

Optionally reference segmentations created by for example a can be used to mask out the image data in those regions. Before masking reference segmentation can also be dilated by for example (one iteration, using a 3D structuring element of 26 connected component).

This atlas can be created from selected groups of subjects with specific properties like sex, age, body shape and size of other characteristics that might be of importance for the image registration accuracy.

An atlas can similarly be created from tissue volume information by use of for example the Jacobian determinant of the deformation fields from the image registrations.

A divergence image was calculated as a z-score image where the difference between the individual PET image intensity is scaled by the standard divergence of the synthetic healthy atlas image data. Other methods are also possible to use, e.g. nonparametric. The methods or assumptions made could also vary over the body.

The whole-body health statistical atlas and/or the whole-body divergence image is particularly useful in providing means for automated image inference. In particular, the image inference may comprise at least one of lesion segmentation, disease status identification, disease prognosis, and disease risk estimation.

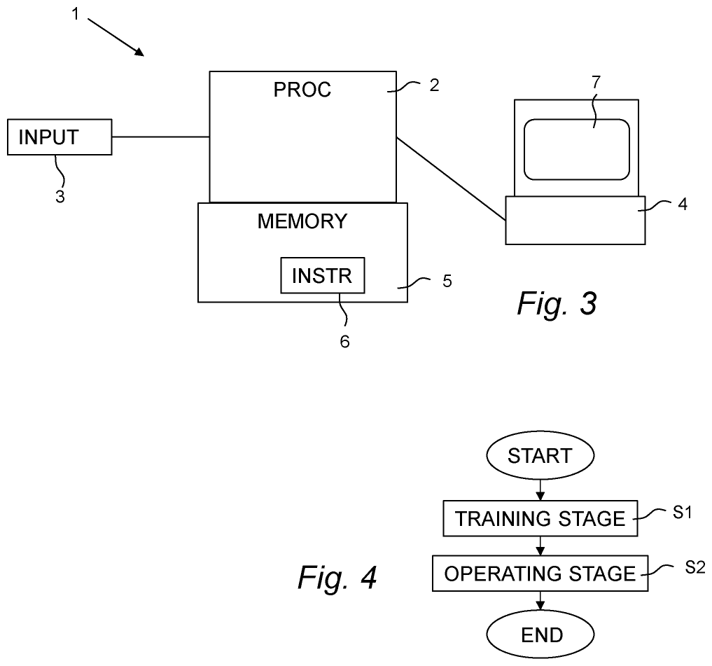

FIG. 3 illustrates schematically an embodiment of a tool 1 for creating a whole-body health statistical atlas. A processor 2 has an input 3 for subject data sets. This input can e.g. be a memory comprising whole-body medical image of a multitude of subjects or a communication device for receiving data representing whole-body medical image of a multitude of subjects. The tool 1 further comprises an output 4 for a whole-body health statistical atlas. This output 4 may e.g. comprise a memory in which representations of resulting images can be stored. The output 4 may alternatively, or in combination, comprise a display device 7 for presenting resulting images. The tool 1 also comprises computer program instructions 6, e.g. stored in a memory 5. This memory 5 may be the same memory that may be comprised in the input 3 and/or output 4 or the memory 5 could be a separate memory.

The computer program instructions 6, when being executed by the processor 2, causes the processor 2 to obtain at least one whole-body medical image of a multitude of subjects by the input 3. At least all except one of the whole-body medical images of the multitude of subjects are registered to a common atlas image space of a common atlas image. The registering is performed with an image registering routine that comprises at least two part registering steps. In at least one of these part registering steps, images of different respective tissues in the whole-body medical images are obtained, and a part registering to the common atlas space is performed by optimizing a weighted cost function comprising a correlation of the images of respective tissues of the whole-body medical image to images of respective tissues of the common atlas image as well as a correlation of the whole-body medical images to a whole-body medical image of the common atlas image. Thereby deformation parameters are obtained, defining the part registration for the whole-body medical image. The computer program instructions 6, when being executed by the processor 2, further causes the processor 2 to depress any identified potential disease contributions from the whole-body medical images of the multitude of subjects. The computer program instructions 6, when being executed by the processor 2, further causes the processor 2 to create a whole-body health statistical atlas in the common atlas image space by using the registered and potential-disease-contribution depressed whole-body medical images of the multitude of subjects.

It is thus understood that in the above described embodiment, the processor 2 is given properties enabling a creation of a whole-body health statistical atlas by the computer program instructions 6.

In other words, in one embodiment, computer program instructions, when being executed by a processor, cause the processor to obtain at least one whole-body medical image of a multitude of subjects. At least all except one of the whole-body medical images of the multitude of subjects are registered to a common atlas image space of a common atlas image. The registering is performed with an image registering routine that comprises at least two part registering steps. In at least one of these part registering steps, images of different respective tissues in the whole-body medical images are obtained, and a part registering to the common atlas space is performed by optimizing a weighted cost function comprising a correlation of the images of respective tissues of said whole-body medical image to images of respective tissues of the common atlas image as well as a correlation of the whole-body medical images to a whole-body medical image of the common atlas image. Thereby deformation parameters are obtained, defining the part registration for the whole-body medical image. The computer program instructions, when being executed by a processor, further cause the processor to depress any identified potential disease contributions from the whole-body medical images of the multitude of subjects. The computer program instructions, when being executed by a processor, further cause the processor to create a whole-body health statistical atlas in the common atlas image space by using the registered and potential-disease-contribution depressed whole-body medical images of the multitude of subjects.

As mentioned further above, whole-body images of voxel-wise state of health can advantageously be used together with neural network approaches. Two examples of such whole-body images of voxel-wise state of health are the above-mentioned whole-body health statistical atlas and the whole-body divergence image. FIG. 4 illustrates schematically a general type of method for obtaining an automated image inference. In a training stage S1, training data sets are provided to a neural network. The training data sets comprises at least medical images of a multitude of subjects, together with associated assigned image inference. The neural network will thereby become trained on such types of data. In an operating stage S2, the trained neural network will be fed by at least one medical images of a subject. The output from the trained neural network will then be an automated image inference of that subject, for instance a non-diagnostic image inference.

In one embodiment, a neural network can be trained by optimizing its output to be as similar as possible to a ground truth or reference inference dataset possible. In segmentation tasks this can be reference segmentations performed by an expert. These references can be performed using a fully manual approach or by different degrees of computerized support. Also fully automated segmentations are possible. The outputs from fully automated approaches are then preferably quality controlled by an export.

The open-source software 3DSlicer (www.slicer.org, version 3.8.1) was used for visual assessments and for the reference segmentations. Tumour lesions were manually segmented on fused FDG PET/CT imaging series. All suspicious high FDG uptake regions were segmented. Window settings and FDG uptake intensity level were adjusted specifically for each case and for each lesion or group of lesions. All detected lesions were segmented including FDG negative, when visible on CT. Manual and semi-automated tools were used for lesion contouring. In case of manual delineation, lesions were delineated on each axial slice and adjusted in coronal and sagittal slices. Semi-automated thresholding tools were used to segment scans with large lesion burden whereafter and all lesions were subsequently corrected manually if needed.

To not fully rely on the typical freehand contouring of the lesions a semi-automated minor adjustment was implemented. It uses lesion-wise PET signal thresholding, but only allows an update of maximum of 1 voxel layer from the first manual reference segmentation.

The method starts from the manual reference segmentation (M). For each lesion the first segmentation mask is dilated and eroded in 3D to create two new masks, respectively. One larger (L) and one smaller (S). The difference between the two new masks is a volume in 3D (R) that covers the manually segmented lesion border (A peal or a “ring” in 3D). PET intensities are then sampled inside (I-inside) and outside (I-outside) the lesion respectively. A threshold value is then determined that separates the high vs low SUV values. The I-inside is sampled as the mean SUV value inside S. The I-outside is sampled as the median intensity in the background in the distance 2-3 voxel layers outside M. The eventual adjustment of M is only allowed inside R. The SUV threshold used was T-SUV=0.5*(I-outside+0.92*I-inside). This was determined heuristically aiming at minimizing the change in segmented lesion volumes and at the same time optimize the intra operator repeatability between two repeated reference segmentations.

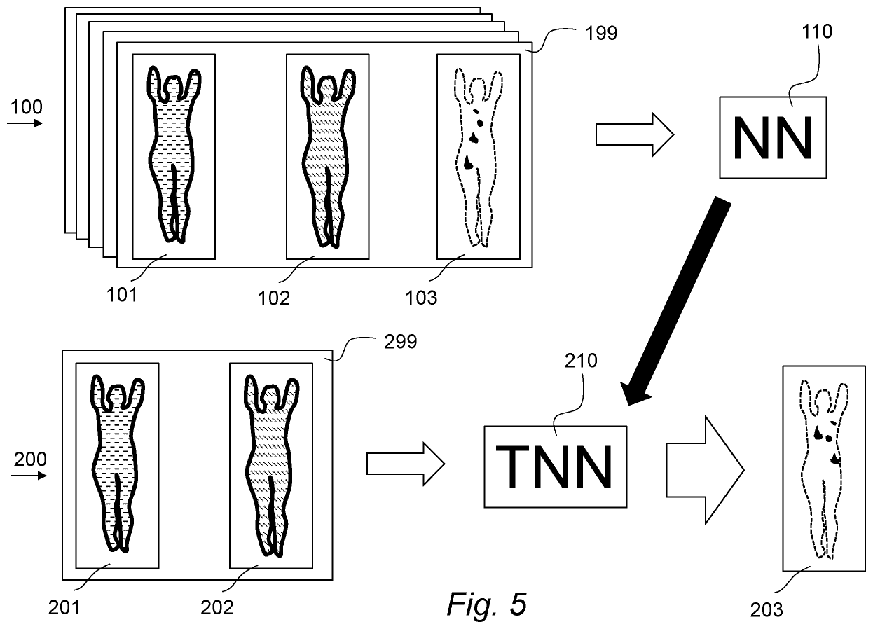

In some prior art, as schematically illustrated by FIG. 5, medical images, e.g. PET 101 and CT 102 images, of a multitude of subjects 100, and the associated assigned image inference 103 was the only content in the training subject data sets 199 provided, as indicated by an unfilled arrow, to the neural network (NN) to be trained 110, thereby resulting, as indicated by a filled arrow, in a trained neural network (TNN) 210. Therefore, only medical images, in this embodiment PET 201 and CT 202 images, of the subject 200 to be analyzed by the trained neural network (TNN) 210 was the only necessary inputted subject data set 299 for performing the automated image inference 203 as an output, as indicated by a wide arrow.

The medical images 101, 102 may in some embodiments be recorded at different times, providing longitudinal information. This is discussed further below.

One of the medical images 101, 102 may also be an image inference, as will be discussed further below.

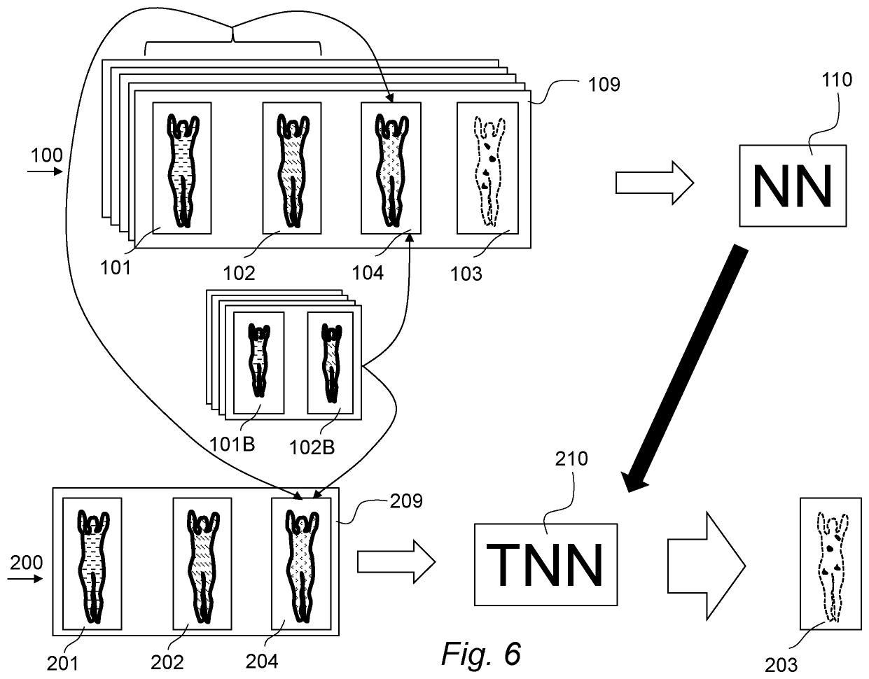

In FIG. 6, another approach is schematically illustrated. Here, in this embodiment, whole-body image of voxel-wise state of health 104 is additionally used in the training subject data sets 109, i.e. the training subject data sets 109 comprises the medical images 101, 102 of a multitude of subjects and the associated assigned image inference 103 as well as the whole-body image of voxel-wise state of health 104. This whole-body image of voxel-wise state of health 104 may be deduced from at least a subset of the medical images, e.g. PET 101 and CT 102 images, of a multitude of subjects 100 actually used in the training subject data sets 109, or they may be deduced from other whole-body medical images, e.g. PET 101B and CT 102B images, or a combination thereof.

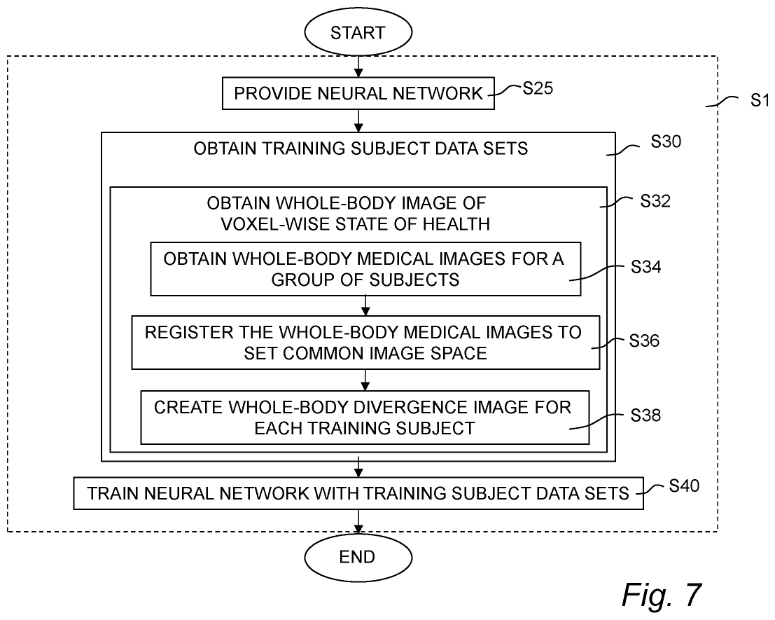

One type of whole-body image of health and/or disease statistical information that has proved to highly improve the quality of the automated image inference is the above-mentioned whole-body health statistical atlas. In FIG. 7, a flow diagram of steps of an embodiment of a method for preparing a tool for automated image inference is illustrated. This method corresponds to a training stage, c.f. S1 of FIG. 4. In step S25, a neural network to be trained is provided. The neural network may be of different kinds, e.g. convolutional neural networks or so called transformer networks. A person skilled in the art is capable of selecting a neural network suitable to be used for image analysis. In a preferred embodiment, the neural network is one of a 3D neural network,
a 2.5D neural network, and a 2D neural network.

In one embodiment, the neural network is trained and evaluated using 4-fold cross validation. In this setup the data in three of the folds are used for training and the remaining fold for validation. This is repeated over all folds and results are averaged.

Segmentations of additional organs and tissues can be added as an additional task for the network that can potentially benefit the training and performance also on other inference tasks (like lesion segmentation).

Convolutional neural networks (CNNs) are often used in image inference applications. Transformer networks or combinations of CNNs and transformers can also be used. Multiple architectures are available and can be used for image inference. Common architectures include e.g. U-Net and V-Net and variants of these. Common frameworks and libraries used are for example Tensorflow, pyTorch, nn_UNet, and MONAI.

Networks can also be so called pre-trained to both increase performance and training speed-up. Networks can be implemented with different dimensionality. Common networks include 2D, where the network is trained to analyse the images slice-by slice. 2D networks that are also fed with neighbouring or orthogonal slices as addition input channels are sometimes described as 2.5D networks. 3D networks are also commonly used. These can also analyse multi-image channel inputs. These can both be of different same types or dynamic 3D data over time as in longitudinal imaging visits.

We have for example inputted a divergence image as an additional input channel and used this to improve a lesion segmentation task. Other inputs an atlas of lesion probabilities in different locations throughout the body or probabilities of also normal appearing tissues is also possible and might improve accuracy or reduce the need for training data.

Ensembling strategies can be used to combine inferences of neural networks with slight variations in training data, hyper parameters, or network models.

Networks can be trained to perform multiple inference tasks, like multi class segmentations of for example lesions and one or more normal appearing organs or tissue. Inclusion of more prior knowledge in the training like from example normal appearing organ or tissue shapes might be beneficial also for the lesion segmentation task.

Cascade approaches where inputs to and outputs from multiple networks are connected can also be used to increase performance of the target inference.

Deep learning approaches can be used to perform image segmentation or image registrations. Image segmentations and image registration can also benefit each other. Combined approaches can also be setup where the inference consists of image segmentations and image registration task that are jointly optimised and where the inferences benefit each other.

In step S30, multiple training subject data sets are obtained. Each training subject data set comprises at least one respective whole-body medical image in a respective set common image space of a set common image. Each training subject data set also comprises an associated assigned image inference of an associated subject. This associated assigned image inference is preferably assigned by a skilled person, such as a physician. Each training subject data set also comprises at least one whole-body image of voxel-wise state of health for each training subject data set registered to the set common image space.

In step S32, the at least one whole-body image of voxel-wise state of health for each training subject data set registered to the set common image space is obtained. The whole-body image(s) of voxel-wise state of health comprise(s) a whole-body divergence image that is based on a comparison between the whole-body medical image of the respective associated training subject and collective image information of a group of subjects.

The step S32 of obtaining at least one whole-body image of voxel-wise state of health registered to the set common image space comprises a number of part steps. In step S34, whole-body medical images for the group of subjects are obtained.

In a preferred embodiment, all subjects of the group of subjects are selected to belong to a specific gender and/or a specific age range and/or a specific body shape class. These whole-body images are thus used for creating the whole-body divergence image. The body shape classes could e.g. be based on the medical image data or BMI measures or other types of measurable geometrical and/or weight data.

In step S36, whole-body medical images of the whole-body medical images for the group of subjects are registered to the set common image space by a common image registering routine. All whole-body medical images of the whole-body medical images for the group of subjects that are not already in the common atlas image space are registered. In a particular embodiment, all whole-body medical images of the whole-body medical images for the group of subjects or all except one of whole-body medical images of the whole-body medical images for the group of subjects are registered. The latter option is the case when the image space of one of the whole-body medical images in fact is the common image space. This common image registration routine is preferably the one described further above and in connection with Appendix A. In step S38, the whole-body divergence image is created by comparing the whole-body medical image of the respective associated training subject with registered the whole-body medical images for said group of subjects. In step S32, the registered whole-body image(s) of voxel-wise state of health is(are) also included into a respective training subject data set.

In step S40, the neural network is trained with the training subject data sets into a trained neural network.

The set common image space is, as the name indicates, an image space to which all images in the set are registered. This is common practice in order to be able to compare different parts of the original images of one set to each other. However, the way to select this set common image space may differ. One alternative is to start from the subject itself. In other words, the set common image space is selected to be equal to a respective training subject image space. This means that all other types of images that are used within one particular set are registered to the image space of the subject, as being available as the whole-body medical image of the subject. The images used in obtaining the whole-body image of voxel-wise state of health are then registered to this whole-body medical image of the subject.

However, the set common image space may also be different from the subject image space. For instance, set common image space may be selected as a specific training subject image space, e.g. associated with another set. This opens up for using the same set common image space for all sets. The set common image space can also be selected as an image space assigned to a specific gender and/or an image space assigned to a specific age group and/or an image space assigned to a specific body shape group. These assigned image spaces may be pre-provided in order to be an image space particularly well suited for the subject in question to be compared to.

If a set common image space different from the subject image space is selected, there has to be a registration of the images of the subject. The step S30 of obtaining multiple training subject data sets in turn comprises substeps. At least one respective whole-body medical image of an associated training subject registered to a respective subject image space is obtained. This at least one whole-body medical image of the training subject data sets is(are) registered to the set common image space, preferably by use of the common image registering routine discussed above, if the image space of the whole-body medical image is different from the set common image space. If the image space of the whole-body medical image already is the set common image space, the registering is obviously unnecessary to perform.

As mentioned above, more than one set may share the same image space. In other words, at least two of the training subject data sets have the same set common image space.

In step S40, the neural network is trained with the registered training subject data sets.

In one embodiment, to not fully rely on the typical freehand contouring of the lesions, a semi-automated minor adjustment was implemented. It uses lesion-wise PET signal thresholding, but only allows an update of maximum of 1 voxel layer from the first manual reference segmentation.

The method starts from the manual reference segmentation (M). For each lesion the first segmentation mask is dilated and eroded in 3D to create two new masks, respectively. One larger (L) and one smaller (S). The difference between the two new masks is a volume in 3D (R) that covers the manually segmented lesion border (A peal or a “ring” in 3D). PET intensities are then sampled inside (I-inside) and outside (I-outside) the lesion respectively. A threshold value is then determined that separates the high vs low SUV values. The I-inside is sampled as the mean SUV value inside S. The I-outside is sampled as the median intensity in the background in the distance 2-3 voxel layers outside M. The eventual adjustment of M is only allowed inside R. The SUV threshold used was T-SUV=0.5*(I-outside+0.92*I-inside). This was determined heuristically aiming at minimizing the change in segmented lesion volumes and at the same time optimize the intra operator repeatability between two repeated reference segmentations.

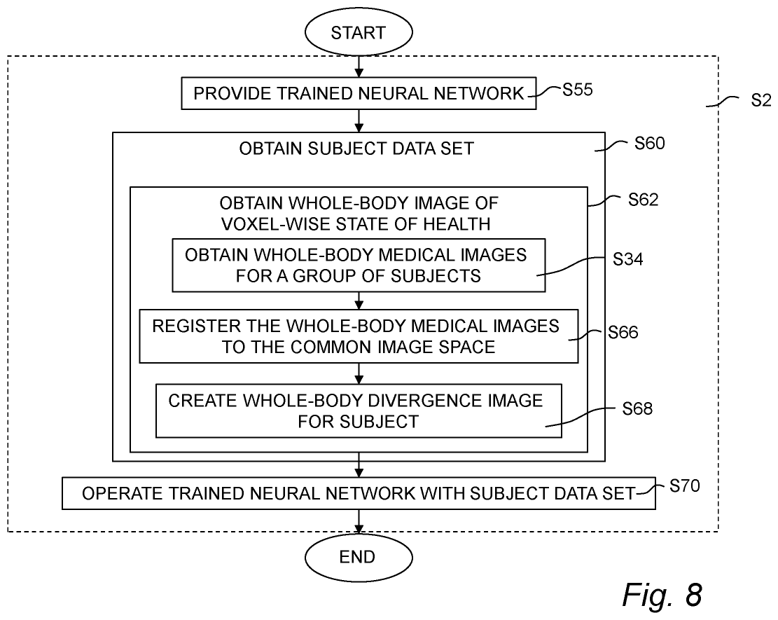

In FIG. 8, a flow diagram of steps of an embodiment of a method for automated image inference is illustrated. This method corresponds to a training stage, c.f. S2 of FIG. 4. In step S55, a trained neural network is provided. This neural network in this step is thus a trained neural network. In a preferred embodiment, the trained neural network is one of a 3D neural network, a 2.5D neural network, and a 2D neural network. The trained neural network is trained with training subject data sets of at least one respective whole-body medical image, an assigned image inference of an associated subject and at least one training whole-body image of voxel-wise state of health, all registered to a set common image space of a set common image. The training whole-body image(s) of voxel-wise state of health comprise(s) a whole-body divergence image based on a comparison between the whole-body medical image of the respective associated training subject and collective image information of a group of subjects. Preferably, the trained neural network is trained by a method according to FIG. 7.

In step S60, a subject data set of at least one whole-body medical image of an associated subject in a common image space of a common image and at least one whole-body image of voxel-wise state of health registered to said common image space is obtained.

In step S62, the at least one whole-body image of voxel-wise state of health registered to said common image space is obtained. This registered at least one training whole-body image of voxel-wise state of health is thus a part of the subject data set. In this embodiment, the at least one whole-body image of voxel-wise state of health comprises a whole-body divergence image that is based on a comparison between the whole-body medical image of the respective associated training subject and collective image information of a group of subjects.

In this embodiment, the step S62 of obtaining at least one whole-body image of voxel-wise state of health registered to the common image space comprises a number of part steps. In step S34, whole-body medical images for the group of subjects are obtained.

In a preferred embodiment, all subjects of the group of subjects are selected to belong to a specific gender and/or a specific age range and/or a specific body shape class, in agreement with a gender and age and body shape class of the associated subject. The whole-body images of these subjects are used for creating the whole-body divergence image,

In step S66, the whole-body medical images for the group of subjects are registering to the common image space by a common image registering routine. This common image registering routine is preferably the one discussed further above and in Appendix A. In step S68, the whole-body divergence image is created by comparing the whole-body medical image of the associated subject with registered whole-body medical images for the group of subjects.

In step S70, the trained neural network is operated with the subject data set as input data, resulting in an image inference.

In analogy with the discussion above, the common image space may be selected in different ways. In one embodiment, the common image space is equal to the subject image space. In such a case, there is obviously no need for any further registration of the whole-body medical image(s) of the associated subject.

In another embodiment, the common image space is different from the subject image space. In such a case, the step S60 of obtaining a subject data set comprises part steps. At least one respective whole-body medical image of the associated subject is obtained in a subject image space. The at least one whole-body medical image of the subject data set is registered to the common image space if the at least one whole-body medical image of the subject data set is in an image space different from the common image space. Preferably, this registration is performed by use of the common image registering routine mentioned above and in connection with Appendix A. If the image space of the whole-body medical image already is the common image space, the registering is obviously unnecessary to perform.

In these cases where a common image space different from the subject image space is selected, different alternatives are available. One possibility is to select another specific subject image space. Alternatively, or in combination, the common image space may be selected an image space assigned to a specific gender and/or an image space assigned to a specific age group and/or an image space assigned to a specific body shape group.

Throughout the procedures of FIGS. 1, 2, 7 and 8, registration of images to a certain image space is performed. In the methods for obtaining the whole-body image of voxel-wise state of health, e.g. the whole-body health statistical atlas, any available whole-body registration method may be useful. However, preferably, the registrations are performed according to the approach exemplified in Appendix A. In the training and operating of the neural network described in connection with FIGS. 7 and 8, the use of the whole-body image of voxel-wise state of health does give an improved result, using many different types of whole-body registration. However, also here, the registration approach exemplified in Appendix A is particularly well suited to cooperate with use of whole-body image of voxel-wise state of health, both for achieving the whole-body health statistical atlases as well as for registering whole-body images during the actual training or operation of the neural network.

The above ideas may be implemented using any type of medical image. However, the types of medical images that so far have given the most promising results are CT images or PET images, or a combination thereof. CT images are also the preferred object for the registration method as discussed in Appendix A. In other words, in one embodiment, the at least one whole-body medical image comprises a whole-body CT image and optionally an additional whole-body PET image.

In one embodiment of the different whole-body image processing schemes described herein, the processed whole-body images are three-dimensional (3D) images. In other words, the whole-body images comprise voxels in three dimensions representing imaging signals from different parts of a three-dimensional subject. In such embodiments, the processed amount of data is very large and the processing of the neural network, both in training and operation stages, requires high computational resources. However, the results are in general very accurate.

Also so-called 4D images, where a “fourth dimension” e.g. in the form of different radiation wavelengths or similar additional parameters, can be used for the purposes of this technology. In other words, in one embodiment, the processed whole-body images may be four-dimensional (4D) images.

In alternative embodiments, the whole-body images are aggregates of parallel two-dimensional (2D) image slices of a 3D image. The 2D image slices may be sagittal image slices. The 2D image slices may also be coronal image slices. Directly recorded 2D images may also be used.

Processing of 2D whole-body images requires in general less computational efforts compared to 3D images. However, the final result using 2D images may be somewhat less accurate than for the 3D cases.

One possibility to improve the 2D image processes is to use additional whole-body image of voxel-wise state of health in the process. It has been found that whole-body maximum intensity projection (MIP) images may assist in improving the final result. The MIP information is the 2D intensity averaged perpendicular to the 2D image slices. To that end, the at least one whole-body image of voxel-wise state of health in the training stage as well as in the operation stage additionally comprises whole-body MIP.

The whole-body MIP may also be used in 3D image cases, but has so far not improved the results significantly.

The produced image inference and the image inference used in the training phase can be of different kinds. In one embodiment, the image inference is non-diagnostic. The image inference may also target certain features that may give a practitioner additional information for making any kind of health-related decisions, diagnostic as well as non-diagnostic. In different embodiments, the image inference may comprise one or more of segmentation, classification, regression and image registration in combination with image segmentation. Some examples may be e.g. lesion segmentation, disease status identification, disease prognosis, and disease risk estimation.

In the embodiments of FIGS. 6 and 7, a whole-body divergence image is used as “additional” data to the neural network, either in the training data sets or in the subject data set, respectively. Such whole-body divergence image may be formed according to different rules, but is typically based on some kind of typical value, e.g. average, median or type values associated to a set of subjects. Any divergence in the medical image of the subject under consideration is then compared in some way to this typical value, preferably in the view of some distribution measures, such as standard divergence, variance etc. In one embodiment, the whole-body divergence image comprises a whole-body medical image of z-scores of a whole-body medical image of a particular subject. This whole-body medical image of z-scores is presented in relation to average and divergence data of whole-body medical image information of a group of subjects.

Preferably, the z-scores comprises subject image intensity difference from an average for the group of subjects, scaled by a standard divergence of intensities for the group of subjects.

As mentioned above, another type of whole-body image of voxel-wise state of health that has proved to highly improve the quality of the automated image inference is a whole-body image based on average data of health statistical whole-body medical image information of a group subjects where any disease contributions are depressed. A typical such whole-body image is the above discussed whole-body health atlas.

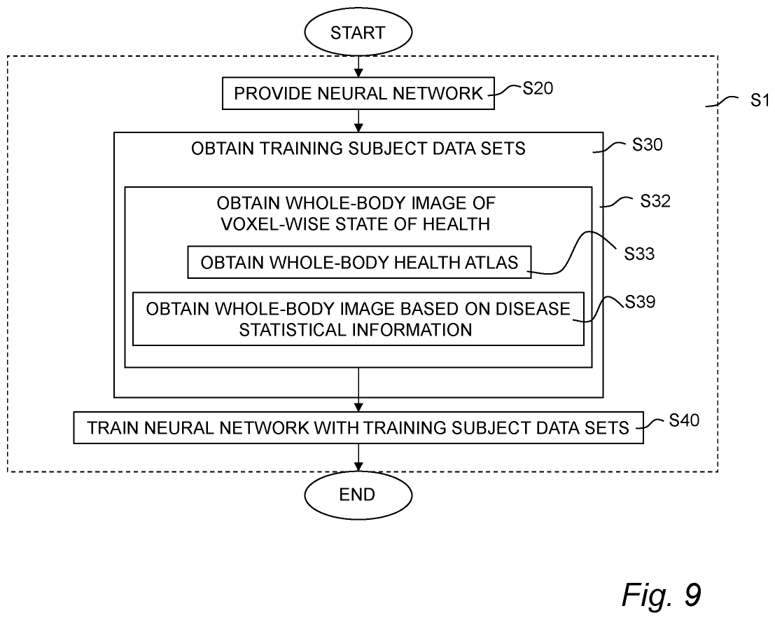

In FIG. 9, a flow diagram of steps of an embodiment of a method for preparing a tool for automated image inference is illustrated. Most steps are the same as in FIG. 7 and are not further discussed. In step S33, a whole-body health atlas, or other whole-body image based on average data of health statistical whole-body medical image information of a group subjects where any disease contributions are depressed, is obtained. The whole-body health atlas is registered to the set common image space and is included in each training subject data set. This type of information is thus used during the subsequent training of the neural network.

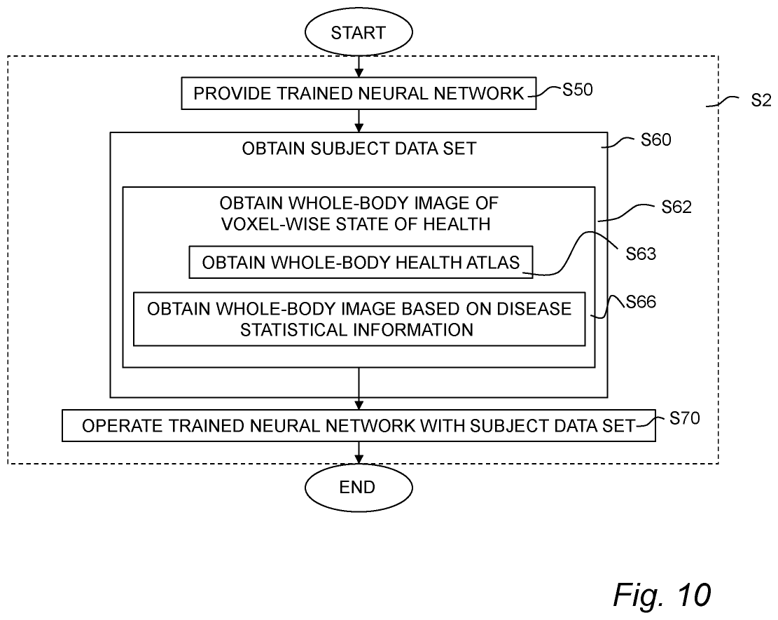

In FIG. 10, a flow diagram of steps of an embodiment of a method for automated image inference is illustrated. Most steps are the same as in FIG. 8 and are not further discussed. In step S63, a whole-body health atlas, or other whole-body image based on average data of health statistical whole-body medical image information of a group subjects where any disease contributions are depressed, is obtained. The whole-body health atlas is registered to the common image space and is included in the subject data set. This type of information is thus used during the subsequent operation of the neural network.

Another type of whole-body image of voxel-wise state of health that has proved to highly improve the quality of the automated image inference is a whole-body image based on disease statistical information. In such a way, information about typical behaviors of certain diseases can explicitly be provided to the neural network for improving its abilities to adapt, also in cases where the amount of training data in general is low. Preferably, the whole-body image based on disease statistical information is a lesion probability image of a group of subjects.

In FIG. 9, where the flow diagram of steps of an embodiment of a method for preparing a tool for automated image inference is illustrated, in step S39, a whole-body image based on disease statistical information is obtained. The whole-body image based on disease statistical information is registered to the set common image space and is included in each training subject data set. This type of information is thus used during the subsequent training of the neural network.

In FIG. 10, where the flow diagram of steps of an embodiment of a method for automated image inference is illustrated, in step S69, a whole-body image based on disease statistical information is obtained. The whole-body image based on disease statistical information is registered to the common image space and is included in the subject data set. This type of information is thus used during the subsequent operation of the neural network.

In FIG. 9, the steps S33 and S39 can be performed as alternatives, or as a combination. The steps S33 and S39 may also be performed as alternatives or combinations with steps S34, S36 and S38 of FIG. 7. In general, the more additional information that is made available for the neural network by means of the whole-body image of voxel-wise state of health, the better the performance of the neural network will be. However, an increased amount of input information will also increase the complexity of the neural network and will therefore need more powerful processing.

Similarly, in FIG. 10, the steps S63 and S69 can be performed as alternatives, or as a combination. The steps S63 and S69 may also be performed as alternatives or combinations with steps S34, S66 and S68 of FIG. 8. The additional information that is made available for the neural network by means of the whole-body image of voxel-wise state of health should of course correspond to the additional information used during training of the neural network.

Tests on segmentation results obtained by deep learning were performed. FDG PET CT scans from n=87 female subjects with metastatic breast cancer from one imaging center were analyzed. 18-FDG PET-CT scans were performed on a Siemens Biograph64 system. All PET scans have been performed in whole body mode, using low dose CT for attenuation correction and localization purposes. CT slice thickness of 3 mm were imaged and 120 kVp were used. All PET scans comprise of 8 bed positions. Total acquisition time per scan was less than 45 min.

The image segmentation was evaluated using different metrics. The main one used was the so-called Dice score that measures the overlap between the reference and the automated segmentation results (metric ranging from 0 to 1).

The image segmentation results from different are shown in Table 1.

TABLE 1
Image segmentation results from a 4-fold cross validation analysis

| | Mean | Median |
|---|---|---|
| Method | Dice | Dice |
| DL | 0.631 | 0.711 |
| DL + Z | 0.652 | 0.753 |
| DL + Z + Ring | 0.659 | 0.750 |
| DL + Z + MIP | 0.662 | 0.743 |
| DL + Z + MIP + Ring | 0.682 | 0.790 |
| DL + Z + MIP + Ring + LP | 0.680 | 0.793 |

DL—Deep learning method (Neural network)
Z—a divergence image in the form of a PET SUV z-score is given as additional input
Ring—Reference segmentations are slightly adjusted to be more objective with the “ring” method
MIP—Maximum intensity projection of the PET image is given as an extra input channel
LP—Lesion probability image is given as additional input channel

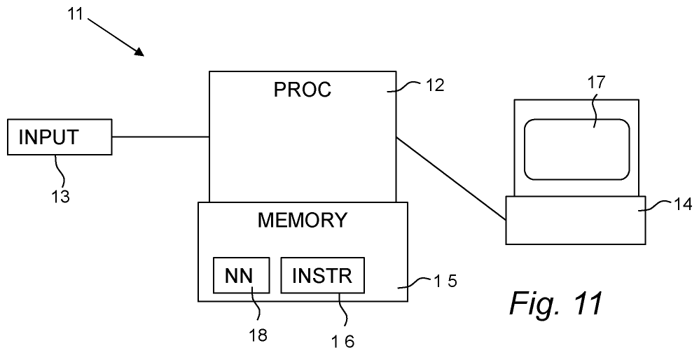

FIG. 11 illustrates schematically an embodiment of a tool 11 for automated image inference. A processor 12 has an input 13 for subject data sets. This input can e.g. be a memory comprising whole-body medical image of a subject or a communication device for receiving data representing whole-body medical image of a subject. The tool 11 further comprises an output 14 for subject image inference. This output 14 may e.g. comprise a memory in which representations of resulting images can be stored. The output 14 may alternatively, or in combination, comprise a display device 17 for presenting resulting images. The tool 11 also comprises computer program instructions 16, e.g. stored in a memory 15. This memory 15 may be the same memory that may be comprised in the input 13 and/or output 14 or the memory 15 could be a separate memory. The memory 15 further comprises a trained neural network 18.

The neural network 18 is a trained neural network. The trained neural network is trained with registered training subject data sets of at least one respective whole-body medical image, an associated assigned image inference of an associated subject and at least one training whole-body image of voxel-wise state of health, all registered to a set common image space of a set common image. In one embodiment, the at least one training whole-body image of voxel-wise state of health comprises a whole-body divergence image based on a comparison between said whole-body medical image of said respective associated training subject and collective image information of a group of subjects. In another embodiment, the at least one training whole-body image of voxel-wise state of health comprises a whole-body image based on average data of health statistical whole-body medical image information of a group subjects where any disease contributions are depressed, typically a whole-body health atlas. In yet another embodiment, the at least one training whole-body image of voxel-wise state of health comprises a whole-body image based on disease statistical information.

The computer program instructions 16, when being executed by the processor 12, causes the processor 12 to form a registered subject data set from a subject data set, obtained by the input 13, of at least one whole-body medical image and at least one whole-body image of voxel-wise state of health. The at least one whole-body medical image and the at least one whole-body image of voxel-wise state of health are in a common space of a common image.

In one embodiment, the at least one whole-body image of voxel-wise state of health comprises a whole-body divergence image that is based on a comparison between the whole-body medical image of the respective associated training subject and collective image information of a group of subjects. The computer program instructions 16, when being executed by the processor 12 causes the processor 12 to obtain whole-body medical images for the group of subjects. The whole-body medical images for the group of subjects are registered to the common image space by a common image registering routine. The whole-body divergence image is created by comparing the whole-body medical image of the associated subject with registered the whole-body medical images for the group of subjects. The common image registering routine is preferably the one discussed further above and in Appendix A.

The computer program instructions 16, when being executed by the processor 12—further causes the processor 12 to operate the trained neural network 18 with the registered subject data set as input data. This results in an image inference that is provided to the output 14.

It is thus understood that in the above-described embodiment, the processor 12 is given properties enabling automated image inference by the computer program instructions 16 and by the trained neural network 18.

In other words, in one embodiment, computer program instructions, when being executed by a processor, cause the processor to form a registered subject data set from an obtained subject data set of at least one whole-body medical image and at least one whole-body image of voxel-wise state of health, in a common space of a common image. The at least one whole-body image of voxel-wise state of health comprises in one embodiment a whole-body divergence image that is based on a comparison between the whole-body medical image of the respective associated training subject and collective image information of a group of subjects. In another embodiment, the at least one training whole-body image of voxel-wise state of health comprises a whole-body image based on average data of health statistical whole-body medical image information of a group subjects where any disease contributions are depressed, typically a whole-body health atlas. In yet another embodiment, the at least one training whole-body image of voxel-wise state of health comprises a whole-body image based on disease statistical information.

In one embodiment, the computer program instructions further cause the processor to obtain whole-body medical images for the group of subjects. The whole-body medical images for the group of subjects are registered to the common image space by a common image registering routine. The whole-body divergence image is created by comparing the whole-body medical image of the associated subject with registered the whole-body medical images for the group of subjects. The common image registering routine is preferably the one discussed further above and in Appendix A.

The computer program instructions further cause the processor to operate a trained neural network with the registered subject data set as input data, resulting in an image inference being provided.

The trained neural network used by the computer program instructions is trained with registered training subject data sets of at least one respective whole-body medical image, an associated assigned image inference of an associated subject and at least one training whole-body image of voxel-wise state of health, all registered to a set common image space of a set common image. The at least one training whole-body image of voxel-wise state of health comprises in one embodiment a whole-body divergence image based on a comparison between the whole-body medical image of the respective associated training subject and collective image information of a group of subjects.

In many cases, when a subject being diagnosed having a disease, a treatment process is started. It is then often requested to follow up the treatment results. If medical images have been taken at the instant in connection with the diagnosis, corresponding images taken after part or full treatment are often useful for evaluating the results. There may thus be sets of medical images associated with a same subject, but recorded at different instances, typically together with image inference at one or both occasions. This enhanced amount of data can also be used within the framework of neural networks.

Longitudinal imaging of a patient can utilise the image data from multiple visits. This also includes eventual segmentations (e.g. lesion segmentation from a baseline visit) to improve the performance of automated segmentation approaches. Deformable image registration can be used to improve the spatial alignment on the longitudinal image information.

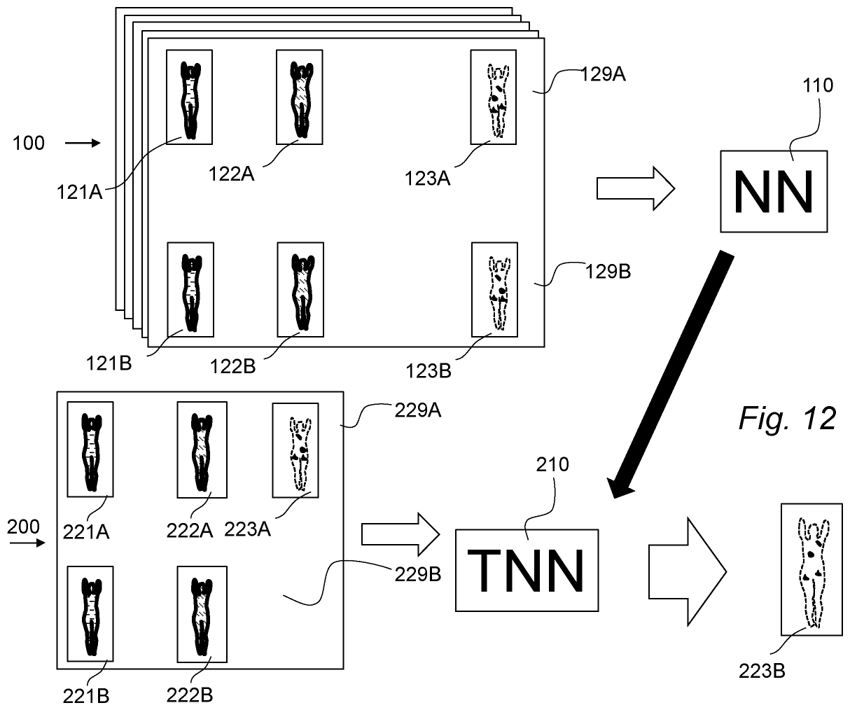

FIG. 12 illustrates schematically an approach based on temporal information of whole-body medical images. Medical images, e.g. PET 121A, 121B and CT 122A, 122B images, of a multitude of subjects 100 are obtained for at least to different occasion. Associated assigned image inferences 123A, 123B where available for at least one of the occasions. For each subject, one training subject data set 129A comprises the medical images 121A, 122A and the associated assigned image inference 123A, if any, of a first instance. Another training subject data set 129B for the same subject comprises the medical images 1211B, 122B and the associated assigned image inference 123B, if any, of a second instance, separated in time from the first instance. Such multi-instance training subject data sets are provided to the neural network 110, for training purposes.

When operating the trained neural network 210, similar sets of medical images 221A, 2211B, 222A, 222B for the target subject are obtained, and optionally also an associated assigned image inference 223A of one of the instances. This data is provided to be analyzed by the trained neural network 210. The result will be an automated image inference 223B of the instant not having an image inference from before.

The procedure is illustrated for two instances. However, these principles can be extended to incorporate also more than two instances.

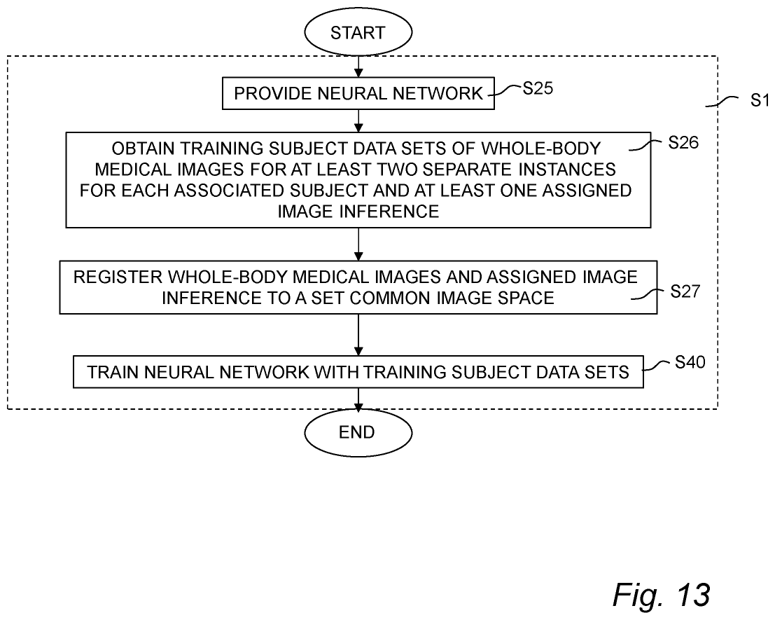

FIG. 13 is a flow diagram of steps of an embodiment of a method for preparing a tool for automated image inference. In step S25, a neural network to be trained is provided. In step S26, multiple training subject data sets are obtained. Each training subject data set comprises at least one respective whole-body medical image of at least two, non-simultaneous, instances of an associated subject and an assigned image inference of the associated subject for at least one of the at least two instances. Preferably, there is an assigned image inference of the associated subject for all instances.

The assigned image inference could be provided in different ways. In one embodiment, the assigned image inference is obtained by human intervention. In an alternative embodiment, the assigned image inference is obtained in statistical ways based on the whole-body medical image of the at least one of the at least two instances.

The assign image inference could also be a result of a previous automatic image inference. This could be provided in addition or as an alternative in one of the instances. In other words, in one embodiment, each of the multiple training subject data sets comprises an assigned image inference of the associated subject for at least another one of the at least two instances being based on an assigned automatic image inference deduced from whole-body medical images of the respective subject.

In a preferred embodiment, at least one of said assigned image inference and the assigned automatic image inference comprises lesion segmentation.

In step S27, the whole-body medical image for at least all except one of the at least two instances and the assigned image inference for each subject are registered to a set common image space of a set common image by use of a common image registering routine. In case the whole-body medical image for one instance is selected as set common image space, that particular image does not have to be registered. In other words, in one embodiment, for each training subject data set, the set common image space is selected to be an image space of the whole-body medical image of one of the at least two instances. In case any other image spaces are selected as the set common image space, all instances have to be registered. The common image registering routine is preferably the one discussed further above and in Appendix A.

In step S40, the neural network is trained with the training subject data sets into a trained neural network.

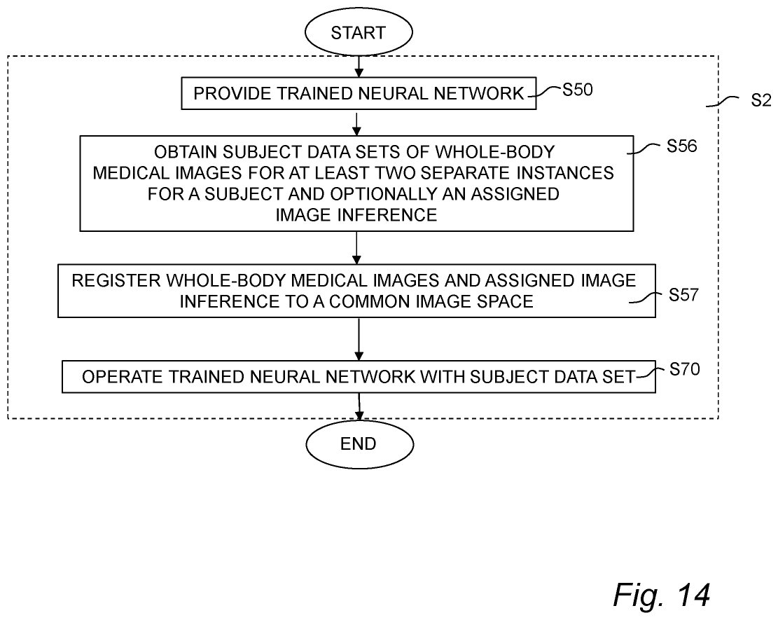

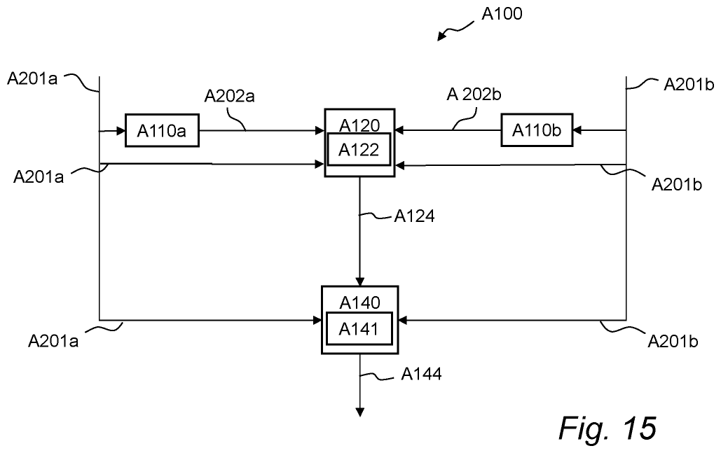

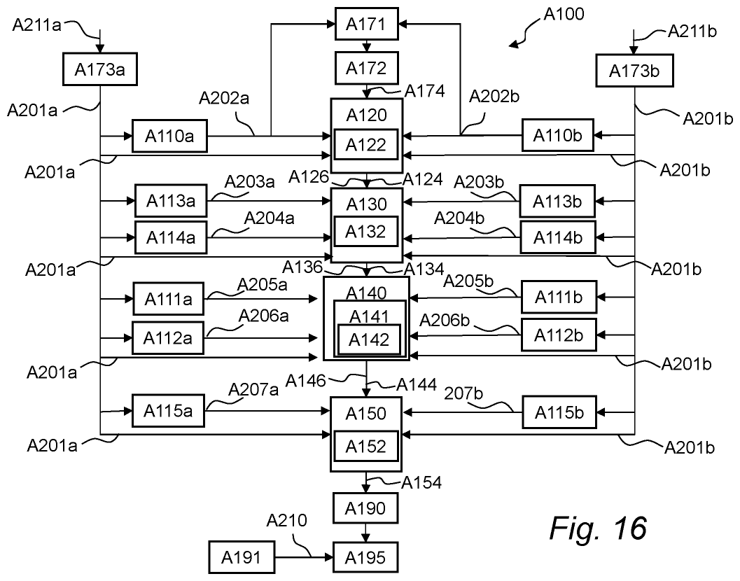

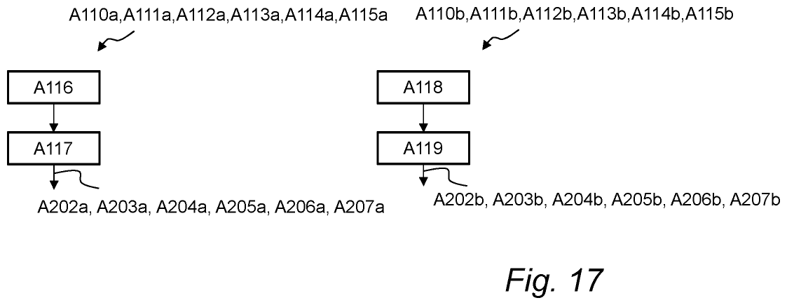

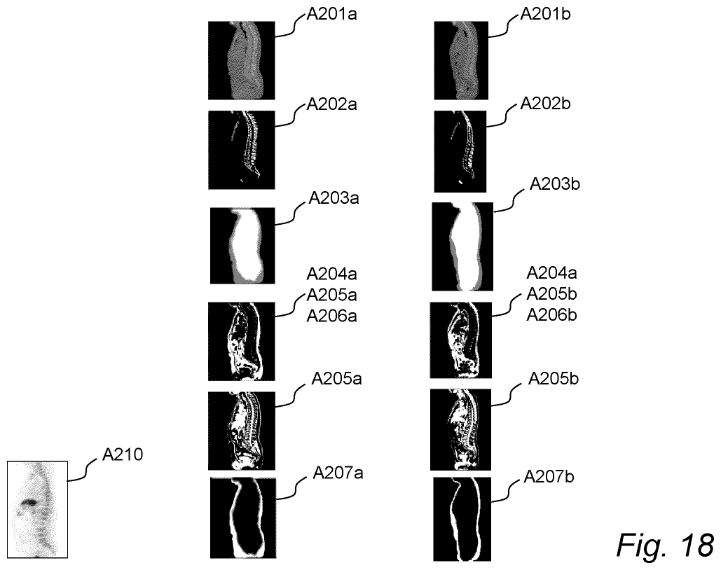

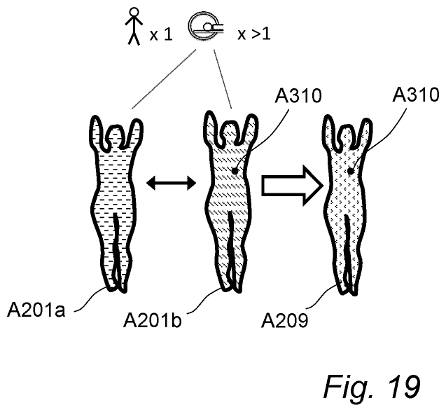

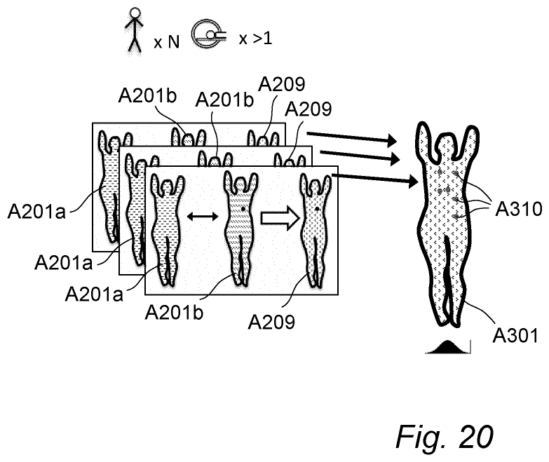

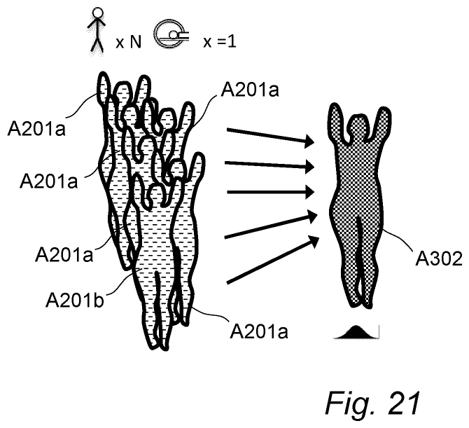

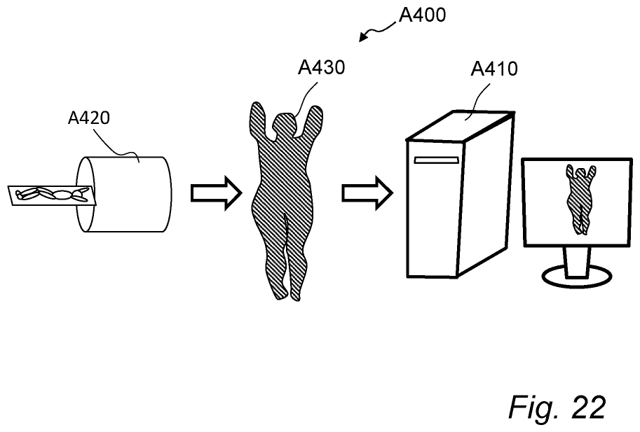

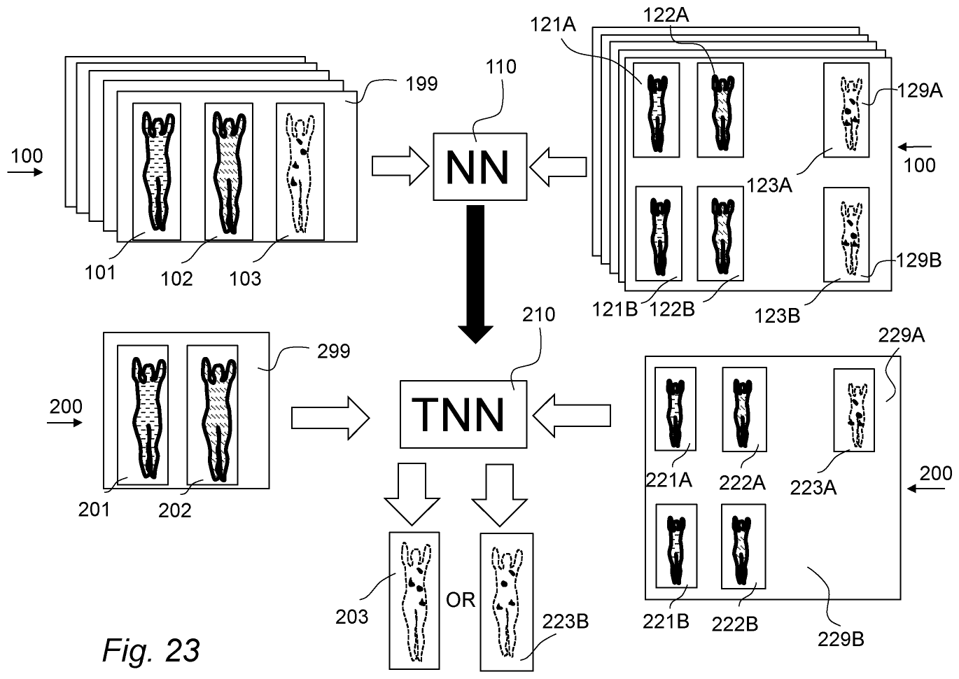

FIG. 14 is a flow diagram of steps of an embodiment of a method for automated image inference. In step S50, a trained neural network is provided. The trained neural network is trained with training subject data sets of at least one respective whole-body medical image of at least two, non-simultaneous, instances, and an assigned image inference of an associated subject for at least one of the at least two instances for each training subject data set, registered to a respective set common image space.

In step S56, —a subject data set of at least one whole-body medical image of at least two, non-simultaneous, instances of an associated subject is obtained. In step S57, the whole-body medical image for at least all except one of the at least two instances is registered to a common image space of a common image by use of a common image registering routine. The common image registering routine is preferably the one discussed further above and in Appendix A.

In step S70, the trained neural network is operated with the subject data set as input data, resulting in an image inference of said associated subject at one of the at least two instances.

In a preferred embodiment, at least one of the assigned image inference and an assigned automatic image inference, if any, comprises lesion segmentation, whereby the neural network is trained with at least one of the assigned image inference and an assigned automatic image inference, if any, comprising lesion segmentation.

In a preferred embodiment, the common image space is selected to be an image space of the whole-body medical image one of the at least two instances.

The approach of using whole-body medical images of more than one instance of a subject can also be enhanced further by also applying the ideas of enhancing the neural network performance by provision of additional information in the form of at least one whole-body image of voxel-wise state of health. Thus, in a preferred embodiment, the method comprises the further step of obtaining at least one whole-body image of voxel-wise state of health registered to the common image space. The training of the neural network then also has to be performed also with the registered at least one whole-body image of voxel-wise state of health as a part of the registered training subject data sets.

In analogy with what has been discussed above, in one embodiment, the at least one whole-body medical image comprises a whole-body CT image and optionally an additional whole-body PET image.

The FIG. 11 may also illustrate a tool for automated image inference based on multi-instance subject data. The important differences compared to previous arrangements are the software and the way in which the neural network has been trained. FIG. 11 thus schematically illustrates an embodiment of a tool 11 for automated image inference. A processor 12 has an input 13 for subject data sets. This input can e.g. be a memory comprising whole-body medical image of a subject or a communication device for receiving data representing whole-body medical image of a subject. The tool 11 further comprises an output 14 for subject image inference. This output 14 may e.g. comprise a memory in which representations of resulting images can be stored. The output 14 may alternatively, or in combination, comprise a display device 17 for presenting resulting images. The tool 11 also comprises computer program instructions 16, e.g. stored in a memory 15. This memory 15 may be the same memory that may be comprised in the input 13 and/or output 14 or the memory 15 could be a separate memory. The memory 15 further comprises a trained neural network 18.

The neural network 18 is a trained neural network. The trained neural network is trained with training subject data sets of at least one respective whole-body medical image of at least two, non-simultaneous, instances, and an assigned image inference of an associated subject for at least one of the at least two instances for each subject data set, registered to a respective set common image space.

The computer program instructions 16, when being executed by the processor 12, causes the processor 12 to form a registered subject data set from at least one whole-body medical image, obtained by the input 13, of at least two, non-simultaneous, instances of an associated subject;

The computer program instructions 16, when being executed by the processor 12, cause the processor 12 to perform a registering of the whole-body medical image for at least all except one of the at least two instances to a common image space of a common image by use of a common image registering routine. The common image registering routine is preferably the one discussed further above and in Appendix A.

The computer program instructions 16, when being executed by the processor 12—further causes the processor 12 to operate the neural network 18 with the registered subject data set as input data. This results in a present image inference of the subject. The present image inference is provided to the output 14.

It is thus understood that in the above-described embodiment, the processor 12 is given properties enabling automated image inference by the computer program instructions 16 and by the trained neural network 18.

In other words, in one embodiment, computer program instructions, when being executed by a processor, cause the processor to form a registered subject data set from at least one whole-body medical image of at least two, non-simultaneous, instances of an associated subject. The computer program instructions further cause the processor to perform a registering of the whole-body medical image for at least all except one of the at least two instances to a common image space of a common image by use of a common mage registering routine. The common image registering routine is preferably the one discussed further above and in Appendix A.

The computer program instructions further cause the processor to operate a trained neural network with the registered subject data set as input data, resulting in a present image inference of the associated subject being provided to the output. The trained neural network is trained with training subject data sets of at least one respective whole-body medical image of at least two, non-simultaneous, instances, and an assigned image inference of an associated subject for at least one of the at least two instances for each subject data set, registered to a respective set common image space.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method for preparing a tool for automated image inference, comprising the steps of:
providing a neural network to be trained;
obtaining multiple training subject data sets, each comprising at least one respective whole-body medical image of an associated subject and an assigned image inference of said associated subject;
wherein said method further comprises at least one of:
i) said associated subject being a training subject in a respective set common image space of a common image, wherein each of said multiple training subject data sets further comprises at least one whole-body image of voxel-wise state of health, associated with said associated training subject, registered to said set common image space;
wherein said at least one whole-body image of voxel-wise state of health comprises a whole-body divergence image being based on a comparison between said whole-body medical image of said respective associated training subject and collective image information of a group of subjects;
wherein said step of obtaining multiple training subject data sets comprises obtaining at least one whole-body image of voxel-wise state of health registered to said set common image space, in turn comprising:
obtaining whole-body medical images for said group of subjects;
registering whole-body medical images of said whole-body medical images for said group of subjects to said set common image space by a common image registering routine; and
creating said whole-body divergence image by comparing said whole-body medical image of said respective associated training subject with registered said whole-body medical images for said group of subjects; and
ii) said at least one respective whole-body medical image being whole-body medical images of at least two instances;
wherein said assigned image inference is an assigned image inference for at least one of said at least two instances;
and the further step of:
registering whole-body medical images of said at least two instances and said assigned image inference for each subject to a set common image space of a set common image by use of a common image registering routine;
wherein said common image registering routine comprises at least two part registering steps, in at least one of which:
images of different respective tissues in said whole-body medical images are obtained,
a part registering to said set common image space is performed by optimizing a weighted cost function comprising a correlation of said images of respective tissues of said whole-body medical images to images of respective tissues of said set common image as well as a correlation of said whole-body medical image to a whole-body medical image of said set common image, thereby obtaining deformation parameters defining said part registration for said whole-body medical image;
wherein said deformation parameters of one part registration step, except for a last part registration step, is used in a subsequent part registration step and wherein said deformation parameters of said last part registration step is used for creating final registered whole-body medical images; and
training said neural network with said training subject data sets into a trained neural network.

2. The method according to claim 1, wherein
said associated subject being a training subject in a respective set common image space of a common image, wherein each of said multiple training subject data sets further comprises at least one whole-body image of voxel-wise state of health, associated with said associated training subject, registered to said set common image space;
wherein said at least one whole-body image of voxel-wise state of health comprises a whole-body divergence image being based on a comparison between said whole-body medical image of said respective associated training subject and collective image information of a group of subjects;
wherein said step of obtaining multiple training subject data sets comprises obtaining at least one whole-body image of voxel-wise state of health registered to said set common image space, in turn comprising:
obtaining whole-body medical images for said group of subjects;
registering whole-body medical images of said whole-body medical images for said group of subjects to said set common image space by a common image registering routine; and
creating said whole-body divergence image by comparing said whole-body medical image of said respective associated training subject with registered said whole-body medical images for said group of subjects.

3. The method according to claim 1, wherein said set common image space is equal to a respective training subject image space.

4. The method according to claim 1, wherein said step of obtaining multiple training subject data sets comprises the steps of:
obtaining at least one respective whole-body medical image of an associated training subject in a respective subject image space;
registering whole-body medical images of said at least one whole-body medical image of said training subject data sets, being in an image space different from said set common image space, to said set common image space by use of said common image registering routine.

5.-7. (canceled)

8. The method according to claim 1, wherein
said at least one respective whole-body medical image being whole-body medical images of at least two instances;
wherein said assigned image inference is an assigned image inference for at least one of said at least two instances;
and comprising the further step of:
registering whole-body medical images of said at least two instances and said assigned image inference for each subject to a set common image space of a set common image by use of a common image registering routine.

9. The method according to claim 1, wherein the method comprises at least one of:
said assigned image inference is obtained by human intervention or in statistical ways based on said whole-body medical image of said at least one of said at least two instances; and
each of said multiple training subject data sets comprises an assigned image inference of said associated subject for at least another one of said at least two instances being based on an assigned automatic image inference deduced from whole-body medical images of said respective subject.

10.-12. (canceled)

13. A method for automated image inference, comprising the steps of:
providing a trained neural network;
wherein said trained neural network being trained with training subject data sets of at least one respective whole-body medical image, and an assigned image inference of an associated subject;
obtaining a subject data set of at least one whole-body medical image of an associated subject; and
operating said trained neural network with said subject data set as input data, resulting in an image inference;
wherein said method further comprises at least one of:
i) said training subject data sets further comprises at least one training whole-body image of voxel-wise state of health, all registered to a set common image space of a set common image and wherein said at least one training whole-body image of voxel-wise state of health comprises a whole-body divergence image based on a comparison between said whole-body medical image of said respective associated training subject and collective image information of a group of subjects;
wherein said subject data set is a subject data set of at least one whole-body medical image of an associated subject in a common image space of a common image, and at least one whole-body image of voxel-wise state of health registered to said common image space;
wherein said at least one whole-body image of voxel-wise state of health comprises a whole-body divergence image being based on a comparison between said whole-body medical image of said associated subject and collective image information of a group of subjects;
wherein said step of obtaining said subject data set comprises obtaining at least one whole-body image of voxel-wise state of health registered to said common image space, in turn comprising:
obtaining whole-body medical images for said group of subjects;
registering whole-body medical images of said whole-body medical images for said group of subjects to said common image space by a common image registering routine; and
creating said whole-body divergence image by comparing said whole-body medical image of said associated subject with registered said whole-body medical images for said group of subjects; and
ii) said training subject data sets are training subject data sets (129A, 129B) of at least one respective whole-body medical image of at least two, non-simultaneous instances;
wherein said assigned image inference is an assigned image inference of an associated subject for at least one of said at least two instances for each training data set, registered to a respective set common image space;
wherein said subject data set is a subject data set of at least one whole-body medical image of at least two, non-simultaneous, instances of an associated subject; and further comprising:
registering whole-body medical images of said at least two instances to a common image space of a common image by use of a common image registering routine;
wherein said common image registering routine comprises at least two part registering steps, in at least one of which:
images of different respective tissues in said whole-body medical images are obtained,
a part registering to said common space is performed by optimizing a weighted cost function comprising a correlation of said images of respective tissues of said whole-body medical image to images of respective tissues of said common image as well as a correlation of said whole-body medical images to a whole-body medical image of said common image, thereby obtaining deformation parameters defining said part registration for said whole-body medical image;
wherein said deformation parameters of one part registration step, except for a last part registration step, is used in a subsequent part registration step and wherein said deformation parameters of said last part registration step is used for creating final registered whole-body medical images.

14. The method according to claim 13, wherein
said training subject data sets further comprises at least one training whole-body image of voxel-wise state of health, all registered to a set common image space of a set common image and wherein said at least one training whole-body image of voxel-wise state of health comprises a whole-body divergence image based on a comparison between said whole-body medical image of said respective associated training subject and collective image information of a group of subjects;
wherein said subject data set is a subject data set of at least one whole-body medical image of an associated subject in a common image space of a common image, and at least one whole-body image of voxel-wise state of health registered to said common image space;
wherein said at least one whole-body image of voxel-wise state of health comprises a whole-body divergence image being based on a comparison between said whole-body medical image of said associated subject and collective image information of a group of subjects;
wherein said step of obtaining said subject data set comprises obtaining at least one whole-body image of voxel-wise state of health registered to said common image space, in turn comprising:
obtaining whole-body medical images for said group of subjects;
registering whole-body medical images of said whole-body medical images for said group of subjects to said common image space by a common image registering routine; and
creating said whole-body divergence image by comparing said whole-body medical image of said associated subject with registered said whole-body medical images for said group of subjects.

15. The method according to claim 13, wherein said common image space is equal to said subject image space.

16. The method according to claim 13, wherein step of obtaining a subject data set comprises the steps of:
obtaining at least one respective whole-body medical image of said associated subject in a subject image space;
registering whole-body medical images of said at least one whole-body medical image of said subject data set, being in an image space different from said common image space, to said common image space by use of said common image registering routine.

17.-18. (canceled)

19. The method according to claim 13, wherein
said training subject data sets are training subject data sets of at least one respective whole-body medical image of at least two, non-simultaneous instances;
wherein said assigned image inference is an assigned image inference of an associated subject for at least one of said at least two instances for each training data set, registered to a respective set common image space;
wherein said subject data set is a subject data set of at least one whole-body medical image of at least two, non-simultaneous, instances of an associated subject; and further comprising:
registering whole-body medical images of said at least two instances to a common image space of a common image by use of a common image registering routine.

20. The method according to claim 13, wherein at least one of said assigned image inference and an assigned automatic image inference, if any, comprises lesion segmentation, whereby said trained neural network being trained with at least one of said assigned image inference and an assigned automatic image inference, if any, comprising lesion segmentation.

21. The method according to claim 13, wherein said common image space is selected to be an image space of said whole-body medical image (201A, 201B, 202A, 202B) one of said at least two instances.

22. (canceled)

23. The method according to claim 13, comprising the further step of creating said whole-body divergence image.

24. The method according to claim 23, wherein said step of creating said whole-body divergence image in turn comprises the steps of:
creating a whole-body health statistical atlas;
obtaining a whole-body medical image of an investigated subject;
registering at least one of said whole-body health statistical atlas and said whole-body medical image to a common image space, using said image registering routine; and
deriving a whole-body divergence image as a comparison between said whole-body medical image of said investigated subject and said whole-body health statistical atlas.

25.-43. (canceled)

44. The method according to claim 1, wherein said image inference comprises at least one of:
segmentation;
classification;
regression; and
image registration in combination with image segmentation.

45. A tool for automated image inference, comprising:
a processor;
an input for subject data sets;
an output for subject image inference; and
computer program instructions;
whereby said computer program instructions, when being executed by said processor cause said processor to form a registered subject data set from a subject data set of at least one whole-body medical image;
whereby said computer program instructions, when being executed by said processor further cause said processor to operate a trained neural network with said registered subject data set as input data, resulting in an image inference being provided to said output;
wherein said trained neural network being trained with registered training subject data sets of at least one respective whole-body medical image, an associated assigned image inference of an associated subject;
whereby said computer program instructions, when being executed by said processor further cause said processor to operate a trained neural network with said registered subject data set as input data, resulting in an image inference being provided to said output;
wherein said computer program instructions, when being executed by said processor, further cause at least one of:
i) said subject data set is a subject data set in a common space of a common image;
said subject data set comprising at least one whole-body image of voxel-wise state of health obtained by said input, in a common space of a common image;
said training subject data sets further comprises at least one training whole-body image of voxel-wise state of health, all registered to a set common image space of a set common image, where said at least one training whole-body image of voxel-wise state of health comprises a whole-body divergence image based on a comparison between said whole-body medical image of said respective associated training subject and collective image information of a group of subjects;
wherein said at least one whole-body image of voxel-wise state of health comprises a whole-body divergence image being based on a comparison between said whole-body medical image of said associated subject and collective image information of a group of subjects;
whereby said computer program instructions, when being executed by said processor cause said processor to:
obtain whole-body medical images for said group of subjects;
register whole-body medical images of said whole-body medical images for said group of subjects to said common image space by a common image registering routine; and
create said whole-body divergence image by comparing said whole-body medical image of said associated subject with registered said whole-body medical images for said group of subjects; and
ii) said subject data set is a subject data set in a common space of a common image;
whereby said computer program instructions, when being executed by said processor cause said processor to form a registered subject data set from at least one whole-body medical image (221A, 221B, 222A, 222B), obtained by said input (13), of at least two, non-simultaneous, instances of an associated subject;
whereby said computer program instructions, when being executed by said processor cause said processor to perform a registering of whole-body medical images of said at least two instances to a common image space of a common image by use of a common image registering routine;
wherein said trained neural network being trained with training subject data sets of at least one respective whole-body medical image of at least two, non-simultaneous, instances, and an assigned image inference of an associated subject for at least one of said at least two instances for each subject data set, registered to a respective set common image space;
wherein said common image registering routine comprises at least two part registering steps, in at least one of which:
images of different respective tissues in said whole-body medical images are obtained,
a part registering to said common space is performed by optimizing a weighted cost function comprising a correlation of said images of respective tissues of said whole-body medical image to images of respective tissues of said common image as well as a correlation of said whole-body medical images to a whole-body medical image of said common image, thereby obtaining deformation parameters defining said part registration for said whole-body medical image;
wherein said deformation parameters of one part registration step, except for a last part registration step, is used in a subsequent part registration step and wherein said deformation parameters of said last part registration step is used for creating final registered whole-body medical images; and
whereby said computer program instructions, when being executed by said processor further cause said processor to operate a trained neural network with said registered subject data set as input data, resulting in an image inference being provided to said output;
wherein said trained neural network being trained with registered training subject data sets of at least one respective whole-body medical image, an associated assigned image inference of an associated subject and at least one training whole-body image of voxel-wise state of health, all registered to a set common image space of a set common image, where said at least one training whole-body image of voxel-wise state of health comprises a whole-body divergence image based on a comparison between said whole-body medical image of said respective associated training subject and collective image information of a group of subjects.

46. Computer program instructions, which computer program instruction, when being executed by a processor cause said processor to form a registered subject data set from an obtained subject data set of at least one whole-body medical image;
whereby said computer program instructions, when being executed by said processor further cause said processor to operate a trained neural network with said registered subject data set as input data, resulting in an image inference being provided to said output;
wherein said trained neural network being trained with registered training subject data sets of at least one respective whole-body medical image, an associated assigned image inference of an associated subject;
whereby said computer program instructions, when being executed by said processor further cause said processor to operate a trained neural network with said registered subject data set as input data, resulting in an image inference being provided to said output;
wherein said computer program instructions, when being executed by said processor further cause at least one of:
i) said subject data set is a subject data set in a common space of a common image;
said subject data set comprising at least one whole-body image of voxel-wise state of health, in a common space of a common image;
said training subject data sets further comprises at least one training whole-body image of voxel-wise state of health, all registered to a set common image space of a set common image, where said at least one training whole-body image of voxel-wise state of health comprises a whole-body divergence image based on a comparison between said whole-body medical image of said respective associated training subject and collective image information of a group of subjects;
wherein said at least one whole-body image of voxel-wise state of health comprises a whole-body divergence image being based on a comparison between said whole-body medical image of said respective associated training subject and collective image information of a group of subjects;
whereby said computer program instructions further cause said processor to:
obtain whole-body medical images for said group of subjects;
register whole-body medical images of said whole-body medical images for said group of subjects to said common image space by a common image registering routine; and
create said whole-body divergence image by comparing said whole-body medical image of said associated subject with registered said whole-body medical images for said group of subjects; and
ii) said subject data set is a subject data set in a common space of a common image;
whereby said computer program instructions, when being executed by said processor cause said processor to form a registered subject data set from at least one whole-body medical image, obtained by said input, of at least two, non-simultaneous, instances of an associated subject;
whereby said computer program instructions, when being executed by said processor cause said processor to perform a registering of whole-body medical images of said at least two instances to a common image space of a common image by use of a common image registering routine;
wherein said trained neural network being trained with training subject data sets of at least one respective whole-body medical image of at least two, non-simultaneous, instances, and an assigned image inference of an associated subject for at least one of said at least two instances for each subject data set, registered to a respective set common image space;
wherein said common image registering routine comprises at least two part registering steps, in at least one of which:
images of different respective tissues in said whole-body medical images are obtained,
a part registering to said common space is performed by optimizing a weighted cost function comprising a correlation of said images of respective tissues of said whole-body medical image to images of respective tissues of said common image as well as a correlation of said whole-body medical images to a whole-body medical image of said common image, thereby obtaining deformation parameters defining said part registration for said whole-body medical image;
wherein said deformation parameters of one part registration step, except for a last part registration step, is used in a subsequent part registration step and wherein said deformation parameters of said last part registration step is used for creating final registered whole-body medical images; and
whereby said computer program instructions further cause said processor to operate a trained neural network with said registered subject data set as input data, resulting in an image inference being provided;
wherein said trained neural network being trained with registered training subject data sets of at least one respective whole-body medical image, an associated assigned image inference of an associated subject and at least one training whole-body image of voxel-wise state of health, all registered to a set common image space of a set common image, where said at least one training whole-body image of voxel-wise state of health comprises a whole-body divergence image based on a comparison between said whole-body medical image of said respective associated training subject and collective image information of a group of subjects.

47. The method according to claim 1, comprising the further step of creating said whole-body divergence image.

48. The method according to claim 47, wherein said step of creating said whole-body divergence image comprises the steps of:
creating a whole-body health statistical atlas;
obtaining a whole-body medical image of an investigated subject;
registering at least one of said whole-body health statistical atlas and said whole-body medical image to a common image space, using said image registering routine;
deriving a whole-body divergence image as a comparison between said whole-body medical image of said investigated subject and said whole-body health statistical atlas.
